(19) United States
(12) Patent Application Publication
(10) Pub. No.: US 2002/0024498 A1
(43) Pub. Date: Feb. 28, 2002

(54) Flat panel display such as for television and channel plate made of glass for flat panel displays and method of manufacture

(76) Inventors: Markus Vos, Ingelheim (DE); Sven Pallhorn, Mainz (DE); Patrick W. Julius, Mainz (DE); Marten Walther, Engelstadt (DE); Tobias Kalber, Mainz (DE); Thomas Kessler, Mainz (DE)

Correspondence Address: NILS H. LJUNGMAN & ASSOCIATES, P. O. BOX 130, GREENSBURG, PA, 15601-0130, US

(21) Appl. No.: 09/870,381

(22) Filed: May 30, 2001

(30) Foreign Application Priority Data
May 31, 2000 (DE) 100 26 974.5-33

(51) Int. Cl. G09G 5/00

(52) U.S. Cl. 345/156

(57) ABSTRACT

A television flat panel display which has a housing, a viewing screen disposed in the housing; the viewing screen comprises a first sheet disposed in the housing as the front sheet of the display, a power input arrangement configured and disposed to power the display, an arrangement to produce picture elements as pixels, this arrangement at least comprising: an array of electrodes, a material configured to be energized by the electrodes, and addressing circuitry connected to the electrodes and the power input arrangement, the addressing circuitry being configured to convert electrical signal input to the material configured to be energized into optical signal output viewable as pixels on a particular point on the first sheet of the display. The material to be energized and the electrodes are disposed in a channel member. The channel member comprises a plate-like structure with a plurality of ribs forming a plurality of grooves with groove bottom surfaces. The groove bottom surfaces and a ramp-shaped transition to a peripheral area support electrodes which are disposed in a smooth transition between the groove bottom surfaces and the peripheral area. The assembly also includes apparatus to maintain the channel member ans aid first sheet in alignment with respect to one another.

### BACKGROUND OF THE INVENTION

1. Field of the Invention

This invention relates to a television flat panel display and a channel plate made of glass for flat panel displays such as television flat panel displays, and a method for manufacture thereof.

2. Background Information

A television flat panel display generally comprises a housing, a viewing screen disposed in the housing; the viewing screen comprising a first sheet disposed in the housing as the front sheet of the display. A power input arrangement is also provided and configured and disposed to power the display. There is also included an arrangement to produce picture elements as pixels, this arrangement at least comprising: an array of electrodes, a material configured to be energized by the electrodes, and addressing circuitry connected to the electrodes and the power input arrangement, the addressing circuitry being configured to convert electrical signal input to the material configured to be energized into optical signal output viewable as pixels on a particular point on the first sheet of the display.

Flat screen displays offer a number of important advantages when compared to cathode ray tubes (CRT) type displays.

The cathode-ray tube, or CRT, was developed by Ferdinand Braun, a German scientist, in 1897 but was not used in the first television sets until the late 1940s. Although the CRTs found in modern monitors have undergone modifications to improve picture quality, they still follow the same basic principles.

A CRT is essentially a sealed glass bottle without air inside. It begins with a slim neck and tapers outward until it forms a large base. The base is the monitor's “screen” and is coated on the inside with a matrix of thousands of tiny phosphor dots. Phosphors emit light when excited by a stream of electrons: different phosphors emit different colored light. Each dot consists of three portions of colored phosphor: one red, one green, one blue. These groups of three phosphors make up what is known as a single pixel. In the “bottle neck” of the CRT is the electron gun, which is composed of a cathode, heat source and focusing elements. Color monitors have three separate guns, one for each phosphor color. Combinations of different intensities of red green and blue phosphors can create the illusion of millions of colors. This is called additive color mixing and is the basis for all color CRT displays.

Images are created when electrons, fired from the electron gun, converge to strike their respective phosphor portions (triads) and each is illuminated, to a greater or lesser extent. When this happens, light is emitted, in the color of the individual phosphor blobs. The gun radiates electrons when the heater is hot enough to liberate electrons (negatively charged) from the cathode, which are then narrowed into a tiny beam by the focus elements. The electrons are drawn toward the phosphor dots by a powerful, positively charged anode, located near the screen.

The phosphors in a group are so close together that the human eye perceives the combination as a single colored pixel. Before the electron beam strikes the phosphor dots, it travels thorough a perforated sheet located directly in front of the phosphor layer known as the “shadow mask”. Its purpose is to “mask” the electron beam, forming a smaller, more rounded point that can strike individual phosphor dots cleanly and minimize “overspill”, where the electron beam illuminates more than one dot. The beam is moved around the screen by magnetic fields generated through a deflection yoke. It starts in the top left corner (as viewed from the front) and flashes on and off as it moves across the row, or “raster”. When it impinges on the front of the screen, the energetic electrons collide with the phosphors that correlate to the pixels of the image that is to be created on the screen. These collisions convert the energy into light. Once a pass has been completed, the electron beam moves down one raster and begins again. This process is repeated until an entire screen is drawn, at which point the beam returns to the top to start again.

The most important aspect of a monitor is that it should give a stable display at the chosen resolution and color palette. A screen that shimmers or flickers, particularly when most of the picture is showing white, can cause itchy or painful eyes, headaches and migraines.

A monitor's three key specifications are:

the maximum resolution it will display,

at what refresh rate, and

whether this in interlaced or non-interlaced mode.

Resolution and refresh rate: resolution in the case of a computer display is the number of pixels the graphics card is describing a desktop with, expressed as a horizontal by vertical figure. Standard VGA resolution is 640×480 pixels. The commonest SVGA resolutions are 800×600 and 1024×768 pixels.

Refresh rate, or vertical frequency: this is measured in Hertz represents the number of frames displayed on the screen per second. Too few, and the eye will notice the intervals in between and perceive a flickering display. The world-wide accepted refresh rate for a flicker-free display is 70 Hz and above. In a computer environment a graphics circuitry creates a signal based on the Windows desktop resolution and refresh rate. This signal is known as the horizontal scanning frequency, HSF, and is measured in KHz. Raising the resolution and/or refresh rate increases the HSF signal. A multi-scanning or “autoscan” monitor is capable of locking on to any signal which lies between a minimum and maximum HSF. If the signal falls out of the monitor's range, it will not be displayed.

Interlacing: an interlaced monitor is one in which the electron beam draws every other line, say one, three and five until the screen is full, then returns to the top to fill in the even blanks (say lines two, four, six and so on). An interlaced monitor offering a 100 Hz refresh rate only refreshes any given line 50 times a second, giving an obvious shimmer. Non-interlaced (NI) is where every line is drawn before returning to the top for the next frame, resulting in a far steadier display. A non-interlaced monitor with a refresh rate of 70 Mz or over is necessary to be sure of a stable display.

The shortcomings of the CRT are well known: it consumes too much energy, its electrode beam design is prone to mis-focus, mis-convergence and color variations occur across the screen, it comprises space-consuming high-voltage electric circuits and strong magnetic fields which create harmful electromagnetic radiation, it is simply too big.

A flat panel display is of considerably less bulk and requires less space accordingly. It may be hung on a wall like a picture. It transmits picture elements without a shadow mask. It is energy efficient.

In principle, the image-generating elements in a flat screen display of one type comprise a multiplicity of flattened and miniaturized tubes: a front plate together with a back plate and the cross-pieces of a channel plate which are perpendicular to one another form hermetically sealed spaces, which are filled with gases and in which application of a voltage produces a glow discharge. By coating the inside of the front plate with suitable substances, light in the desired color can be generated. By combining three image points in the primary colors to form a pixel or picture element, a color display can be achieved analogously to known television sets operating on the basis of Braun tubes. The grid-like arrangement of the electrode leads in rows, which are located on the inside of the front plate, and columns, which are located on the inside of the rear wall, allows each pixel to be addressed specifically.

In other words, in a plasma displays comprise a display in which sets of parallel conductors at right angles to each other are deposited on glass plates, with the very small space between the plates being filled with a gas; each intersection of two conductors defines a single cell that can be energized to produce a gas discharge forming one element of a dot-matrix display.

Display panels of flat screen displays of the type typically used in modern plasma television screens called Plasma Display Panels (PDP) or Plasma Addressed Liquid Crystal (PALC) display panels require channel plates for their operation that have high-precision microstructures in the form of a plurality of parallel microchannels that are separated by webs.

Further, in other words, modern large area or ultra-wide, flat screen displays, so-called plasma display panels (PDPs) and plasma addressed liquid displays (PALCs) require so-called channel plates of glass on which channel plate by means of webs or ribs, also known as barriers or separators, channels are formed and on which channel plate is disposed a defined amount of vertical, in the case of a PDP, or horizontal, in the case of a PALC, conductors, such as strip conductors, as address electrodes. These electrodes are provided on the glass substrate between the rib-like webs, which in turn are formed only after provision of the electrodes or prior to provision of the electrodes.

The assembly of such modern flat screen display panels, particularly of the channel plate, is described at hand of a PDP in the paper by I. H. Doyeux and J. Deschamps, “Plasma Display Panel Technology and Applications,” SID 97 DIGEST, on pages 213-217.

Thus, this invention relates to a channel plate made of glass for flat screen displays that has a plurality of parallel channels separated by webs, which channels are fabricated in the form of microstructures on a flat glass substrate, and the channel plate has a peripheral area to which electrode conductors that are located on the channel bottoms can be led through. The invention further relates to a method for the manufacture of such a channel plate.

Display panels of flat screen displays of the type typically used in modern plasma television screens called Plasma Display Panels (PDP) or Plasma Addressed Liquid Crystal (PALC) display panels require channel plates for their operation that have high-precision microstructures in the form of a plurality of parallel microchannels that are separated by webs. A section of a channel plate of this type is schematically illustrated in FIG. 10 on a greatly enlarged scale. The channel-shaped microstructures visible in this figure must be produced economically and in large numbers of units for various display sizes (diagonal screen measurements up to 60″ and larger). Depending on the screen format, the structure dimensions are in the following ranges: web interval X=50-1000 micrometers, web height Y=50-300 micrometers and web width Z=20-100 micrometers. For a 42 inches HiVision PDP display, for example, it is necessary to fabricate approximately 5760 channels with a pitch, i.e. the interval between the webs “X”, of approximately 161 micrometers with a web height “Y” of 150 micrometers and a web width “Z” of 30 micrometers with tolerances of a few micrometers, over a length of approximately 520 millimeters.

Between zero and three conducting paths are applied in the form of electrodes in each of the channels between the rib-shaped webs, depending on the type of display.

The structure of these modern flat screen displays, and the structure of the channel plate in particular, is described in the prior art.

The prior art describes various methods for the realization of the channel structure. In one method, the webs are laid down using the screen printing method with the formation of channels in a plurality of layers, one after the other, on a flat glass substrate. This method is very complex, time-consuming and expensive.

In another method, the channel structures are shaped in the flat glass substrate.

This shaping can be done in a variety of different ways.

The prior art describes the generation of the channel microstructures using hot forming by embossing.

The prior art also teaches the use of sandblasting via a microstructured mask to generate the channel microstructures. Attempts have also been made to structure the channels using a grinding process. During the grinding, a high-precision multiple-disc grinding tool is used which has a plurality of precision grinding discs on a common spindle spaced axially from one another with high precision by spacer rings. Because the channels are very finely structured and are very close to one another, the manufacture of the channel plates by grinding using the multiple-disc grinding tool presents all sorts of problems, including the fact that the individual grinding discs of the multiple-disc grinding tool cannot always be located at the correct small axial distances from one another. Therefore the distance between the individual grinding discs is a whole-number multiple of the pitch “X” of the webs. Because the length of the multiple-disc grinding tool is limited by the oscillation behavior of the machining spindle and by the speed of rotation, the channel plates are fabricated using offset grinding, in which the channel plate is structured by multiple passes of the multiple disc grinding tool. Between the individual passes, the multiple-disc grinding tool is offset at a right angle to the longitudinal axes of the channels, and specifically by the pitch to be fabricated. The channel plates have, on at least one side, a flat peripheral area, to which the metal electrode conductors that can be applied to the channel bottoms are led through for connection purposes. The upper plane of the flat peripheral area is thereby at the specified height of the channel bottoms to be shaped. If the channels are formed in the flat glass substrate using the methods described above, the depth of the channels will be different on account of unavoidable manufacturing tolerances, i.e. the height of the channel bottoms fluctuates with reference to the upper plane of the peripheral area and transition steps are formed, the presence of which has a disadvantageous effect on the photolithographic structuring of the metal electrode conductors and their mechanical resistance to tensile and compression stresses.

### OBJECT OF THE INVENTION

The object of the invention is to realize the glass channel plate described above for flat screen displays so that the electrode lead-throughs can be structured correctly and have sufficient mechanical strength.

### SUMMARY OF THE INVENTION

The invention teaches that this object may be accomplished, in accordance with one embodiment of the invention by a television flat panel display, said television flat panel display comprising: a housing; a viewing screen disposed in said housing; said viewing screen comprising a first sheet; said first sheet being disposed in said housing as the front sheet of said flat panel display; a power input arrangement configured and disposed to power said flat panel display; an arrangement to produce picture elements as pixels, said arrangement at least comprising: an array of electrodes; a material configured to be energized by said electrodes to produce radiation viewable as pixels through said first sheet; and addressing circuitry connected to said array of electrodes and said power input arrangement; said addressing circuitry being configured to convert electrical signal input to said material configured to be energized into optical signal output viewable as pixels on a particular point on said first sheet of said flat panel display; and a channel member; said material to be energized to produce pixels being disposed in said channel member; apparatus to maintain said channel member and said first sheet in alignment with respect to one another; said channel member comprising a plate-like structure; said plate-like structure having a longitudinal dimension, a transverse dimension transverse to said longitudinal dimension, and a thickness; said thickness of said plate-like structure being substantially less than either said longitudinal dimension and said transverse dimension; said channel member comprising a first surface and a second surface; said first surface being configured as a substantially planar surface; said second surface being disposed substantially parallel and opposite to said first surface; said channel member comprising glass; said second surface comprising a plurality of ribs; said ribs defining a plurality of grooves extending across said longitudinal dimension and said transverse dimension of said channel member; said grooves being configured as micro structure channels being spaced apart to correspond to television pixel resolution of said television flat panel display; said grooves being configured of substantially rectangular u-shape when considered in transverse cross-section; said grooves comprising bottom surfaces extending towards said first surface; said ribs extending substantially parallel with respect to one another; said ribs having a thickness sufficient to provide mechanical stability to said ribs and their corresponding grooves; said ribs being spaced apart at a predetermined pitch to correspond to pixel resolution of said flat panel display; said ribs being configured with substantially smooth side walls; said side walls being disposed substantially perpendicularly to said first surface; said ribs comprising inner portions and outer portions; said inner portions being disposed between said first surface and said outer portions; said outer portions projecting away from said first surface; said channel member comprising at least one peripheral area being configured to support at least portions of said electrodes; and a transition area being disposed between said groove bottom surfaces and said at least one peripheral area; said transition area being configured without a step; said electrodes being disposed in said transition area in a substantially smooth transition from said groove bottom surfaces to said at least one peripheral area, thereby permitting the existence of substantial variations due to manufacturing tolerances in the differences between the level of said at least one peripheral area and the levels of said groove bottom surfaces to occur.

The invention also teaches that, on a glass channel plate for flat screen displays which has a number of parallel channels separated by webs, which channels are microstructured by shaping in a flat glass substrate and the channel plate has a peripheral area to which electrode conductors can be led through on the channel bottoms, and the transition from the channel bottoms to the peripheral area is shaped so that regardless of manufacturing tolerances, there is no step between the channel bottoms and the peripheral area.

The realization of the channel plate as claimed by the invention makes it possible to easily lead the electrodes through to the peripheral connections area.

In a first development of the invention, the channel plate is structured so that the continuous transition to the peripheral area has a flat, ramp-shaped surface that descends toward the edge onto a flat area, with the highest point of the ramp that lies higher by a specified dimension and a lowest point that lies lower by a specified dimension than the specified height of the channel bottoms.

It is thereby possible to compensate in both directions for manufacturing tolerances in the shaping of the channel structures.

The arrangement is preferably realized so that the highest point of the ramp is at the level of the upper edges of the webs and the lowest point of the ramp is lower than the specified height of the channel bottoms by at least twice the manufacturing tolerance.

In a second development of the invention, the channel plate can be realized so that the peripheral area is essentially at the same height as the upper edge of the web, and there is a rounded transition from the channel bottom to the peripheral area. In both types of embodiment, the continuous transitions are preferably ground in, which can be done particularly economically in terms of the manufacturing operations involved, in particular if, as in one further development of the invention, the channel structure is also ground into the glass substrate. It is thereby appropriate to surface-grind the glass substrate, at least on the side on which the grinding process is applied, to thereby reduce the tolerances in the depth direction of the channels. With regard to the method for the manufacture of the channel plate, the solution taught by the invention includes the following steps:

Preparation of a flat, rectangular glass plate with specified dimensions,

Shaping of a continuous transition between the area of the glass plate in which the channels are to be worked and at least one of the peripheral areas in which the channels emerge, and

Shaping of the channels in the glass plate, preferably by grinding.

Characterizing features of additional developments of the invention are disclosed in the dependent claims and are illustrated in the accompanying figures.

The above-discussed embodiments of the present invention will be described further hereinbelow. When the word “invention” is used in this specification, the word “invention” includes “inventions”, that is the plural of “invention”. By stating “invention”, the Applicants does not in any way admit that the present application does not include more than one patentably and non-obviously distinct invention, and maintains that this application may include more than one patentably and non-obviously distinct invention. The Applicants hereby assert that the disclosure of this application may include more than one invention, and, in the event that there is more than one invention, that these inventions may be patentable and non-obvious one with respect to the other.

### BRIEF DESCRIPTION OF THE DRAWINGS

The invention is explained in greater detail below with reference to the two exemplary embodiments that are illustrated in the accompanying figures, in which:

FIG. 1: is a perspective view of a television flat panel display viewed from the front;

FIG. 2: is a perspective view of a television flat panel display viewed from the side;

FIG. 3: is a schematic block diagram of a flat panel display;

FIG. 4: is a perspective view of a portion of a flat panel display showing particularly the channels of a flat panel display and electrodes located in the channels;

FIG. 5: is a perspective view similar to FIG. 4 illustrating pixel or picture element generation;

FIG. 6: is an enlarged cross-section of a portion of a flat panel display illustrating the generation of a single pixel or picture element;

FIGS. 7A and 7B: is a cross-sectional view (FIG. 7A) and an overhead view (FIG. 7B) of a channel plate with an introduced channel structure and a ground, ramp-shaped peripheral area to which the electrode conductors can be led through, in a first exemplary embodiment;

FIG. 8: is a schematic cross section through the channel plate illustrated in FIGS. 7A and 7B of a second exemplary embodiment for grinding a continuous transition between the structured channel bottoms and the peripheral area to which the electrode conductors can be led through;

FIG. 9: is a two-step schematic cross-section of a channel structure with web upper edges that are covered by a nontransparent coating;

FIG. 10: illustrates the channel structure of the prior art of a channel plate in a schematic, simplified drawing in perspective;

FIG. 11: is a view similar to FIG. 7A showing further details;

FIG. 12: is a view similar to FIG. 7B showing further details;

FIG. 13: is a cross-sectional view similar to FIG. 11 showing an electrode in place;

FIG. 14: is a top plan view similar to FIG. 12 showing the electrode in place; and

FIG. 15: is a cross-sectional view of a channel member with a rounded section.

### DESCRIPTION OF THE PREFERRED EMBODIMENT

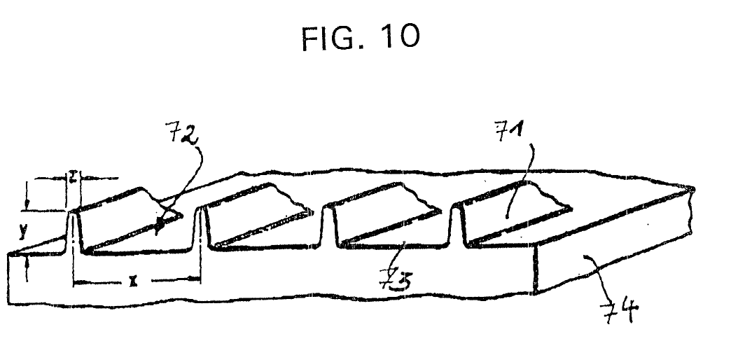

FIG. 10 is an enlarged and greatly simplified illustration of the structure of the prior art of a channel plate for modern flat screen displays. This channel plate has a plurality of parallel channels 72 that are separated by webs 71. Zero to three electrodes are applied to the bases 73 of the channels, depending on the type and model of the display.

A glass plate of this type is manufactured in the following steps:

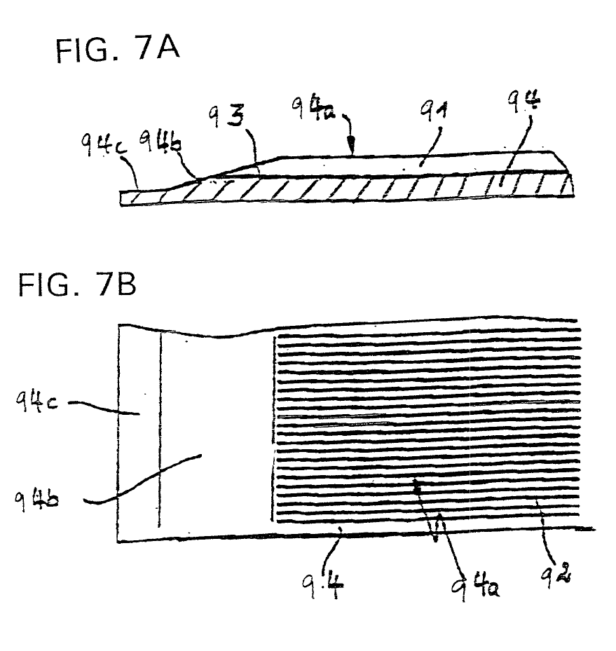

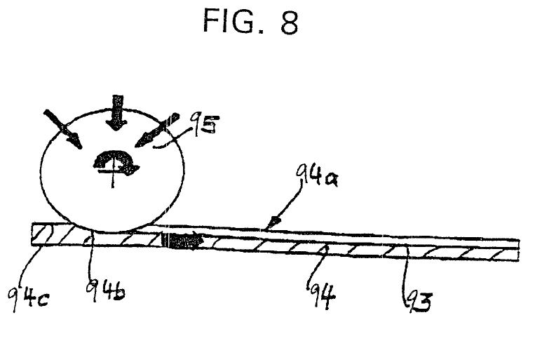

With reference to FIGS. 7A, 7B and 8, first, a flat, rectangular glass plate 94, the glass substrate, is prepared with specified dimensions that correspond to the required screen size. This glass plate is preferably manufactured by floating or drawing and is preferably made of borosilicate glass.

Glass plates manufactured in this manner typically have wave-shaped irregularities with a long wavelength on their surfaces called “warp”, and a waviness with a very short wavelength. The warp and the waviness can be minimized by surface grinding of one or both sides of the glass surface in the next optional step, with a resulting reduction of the tolerance range of the structured channel plate.

When a suitable grinding disc is used, the flat-ground, or surface-ground, glass surface minimizes undesirable leakage radiation and thus increases contrast when the channel plate is used in a PALC display.

The structuring of the channels 92 in the surface-ground glass plate 94 in its active area 94a is done using one of the methods described above, preferably by grinding the channels using a high-precision multiple-disc grinding tool.

High-precision multiple-disc grinding nodules of this type typically have a plurality of precision grinding discs mounted on a common spindle that are kept at a precise axial distance from one another by spacer rings, for the simultaneous grinding of parallel microstructures in a workpiece. The grinding discs must thereby be at a highly precise distance from one another with very small tolerances. For the reasons indicated above, the channel structure is thereby created by the offset grinding method described above.

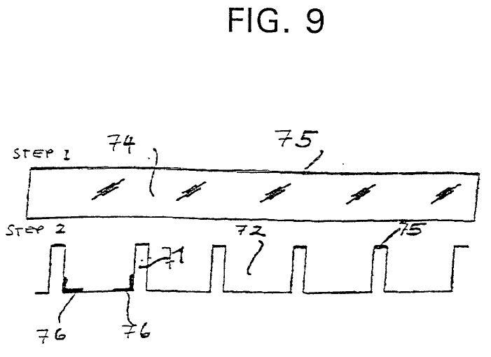

Then the metal conductors are introduced in the form of electrodes into the channels 92, depending on the type of display. The metal conductors are preferably applied using zeroexternal-current and galvanic methods for depositing metal with photolithographic structuring of the electrode areas as disclosed in the older German Patent Application 198 41 900.7-33, the disclosure of which is also incorporated by reference in the disclosure content of this application. Other methods such as sputtering and vapor deposition plating can also be used. These metal conductors (76 in FIG. 9) must be led through for connection purposes from the channel bottoms 93 to a peripheral area of the channel plate, whereby the upper surface of the peripheral area is at the specified height of the channel bottoms 93. This particular requirement results in the problem described below.

As a result of the unavoidable positioning and feed tolerances during the grinding process or the other shaping processes, there are different heights of the channel bottoms 93 and the peripheral area of the channel plate, i.e. there is a step between the peripheral area to which the electrodes are led through. In other words, as a result of the unavoidable positioning and feed tolerances during the grinding process or the other shaping processes, there are different heights of the channel bottoms 93 and the peripheral area of the channel plate, i.e. there is a step between the channel bottoms and the peripheral area to which the electrodes are led through. The presence of this step has a negative effect on the photolithographic structuring of the electrodes when the conductors are laid down. For example, lacquer accumulates in concave corners, and there is no lacquer coverage of convex corners. This situation results in short circuits and discontinuities in the metal conductor paths. The electrodes deposited are also subjected locally to high loads caused by tensile and compression stresses. The invention therefore teaches the shaping of a continuous transition between the connection area and the channel bottoms, a transition that is preferably ground in. In the exemplary embodiment illustrated in FIGS. 7A and 7B, in the peripheral area of the channel plate 94, prior to the structuring, a flat area 94b is formed in the shape of a ramp that runs at an angle toward the edge by a grinding disc of appropriate width and contour for example, starting from the upper side of the channel plate. The flat area 94b emerges into a flat connecting area 94c, which lies lower than the specified height of the channel bottoms 93. This configuration guarantees that the metal conductor paths of the electrodes need not overcome any step between the bottom of the channel and the peripheral area, not even a step that is within the specified tolerances for the fluctuating actual height of the channel bottoms.

The transition between the peripheral area 94b, 94c and the channel bottoms 93, which runs at an obtuse angle, creates the conditions for a significantly better photolithographic structurability of the electrodes and reduced stresses in the finished electrodes, so that there are no short circuits and discontinuities, and the danger of broken electrodes is significantly reduced. This measure therefore leads to an increased yield in the production of the channel plates.

The slope of the ramp 94b can be 3 degrees, for example, and the lowest point of the ramp can be 10 micrometers lower than the specified height of the channel bottom 93, for example. The ramp bevel 94b is preferably shaped so that the lowest point is lower than the specified height of the channel bottom by twice the manufacturing tolerance.

An additional possibility for improving the photolithographic structurability and reducing the mechanical stresses on the electrodes is to obtain a continuous transition between the surface of the glass plate 94 and the channel bottom. This arrangement can be achieved, for example, as illustrated in FIG. 8, before the beginning of the structuring of the channels 92, by plunge-cutting with the rotating grinding wheel 95 of a grinding tool into the glass plate 94 vertically from above or at a specified angle.

Thus the radius of the disc 95 is reproduced in the peripheral area 94b of the structure. This radius also results in a continuous transition between the channel bottom and the glass surface of the channel plate in the peripheral area 94b. This method also reduces the mechanical load on the electrode. An additional advantage of plunge-cutting with the grinding wheel 95 into the glass plate 94 is that there is no need for a separate machining of the periphery of the glass plate. It thereby becomes possible to eliminate one more manufacturing or process step.

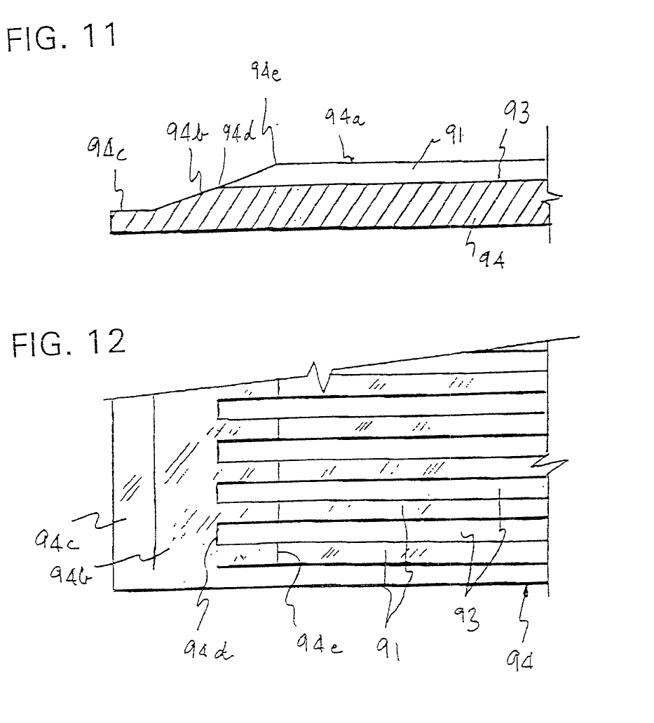

FIGS. 11 and 12 show the merging 94d at the groove bottom 93 and the peripheral sloped area 94b; and the conjunction 94e at the top of a rib or web 91 and the apex of peripheral sloped area 94b.

The peripheral area can also be used to install and support a microsheet (thin glass) or as a mechanical support for a glass cover.

One feature of the invention resides broadly in a channel plate made of glass for flat screen displays which has a plurality of parallel channels 92 separated by webs 91, which channels are fabricated in the form of microstructures on a flat glass substrate 94, and the channel plate 94 has a peripheral area 94b, 94c to which electrode conductors can be led through on the channel bottoms 93, characterized by the fact that the transition from the channel bottoms to the peripheral area 94b, 94c is shaped so that regardless of manufacturing tolerances, there is no step between the channel bottoms and the peripheral area.

Another feature of the invention resides broadly in a channel plate characterized by the fact that the continuous transition to the peripheral area has a ramp-shaped flat area 94b which descends toward the periphery onto a flat area 94c, with the highest point of the ramp lying higher by a specified dimension and a lowest point that lies lower by a specified dimension than the specified height of the channel bottoms 93.

Yet another feature of the invention resides broadly in a channel plate characterized by the fact that the highest point, of the ramp, lies at the level of the upper edges of the webs.

Still another feature of the invention resides broadly in a channel plate characterized by the fact that the peripheral area lies essentially at the same height as the upper edge of the web and a rounded transition is shaped from the channel bottom 93 to the peripheral area.

A further feature of the invention resides broadly in a channel plate characterized by the fact that the continuous transition is ground in.

Another feature of the invention resides broadly in a channel plate characterized by the fact that the channel structure is ground into the glass substrate 94.

Yet another feature of the invention resides broadly in a channel plate characterized by the fact that the glass substrate 94 is subjected to a high-precision surface grinding on at least one side.

Still another feature of the invention resides broadly in a method for the manufacture of a channel plate comprising the following steps:

Preparation of a flat, rectangular glass plate with specified dimensions,

Shaping of a continuous transition between the area of the glass plate in which the channels are to be worked and at least one of the peripheral areas in which the channels emerge, and

Shaping of the channels in the glass plate, preferably by grinding.

A further feature of the invention resides broadly in a method in which the shaping of a continuous transition by grinding of a peripheral area into which the channels emerge is done on at least one side of the glass plate which has a ramp-shaped flat area that descends toward the edge onto a flat area, with the highest point lying higher by a specified dimension and the lowest point lying lower by a specified dimension than the specified height of the channel bottoms.

Another feature of the invention resides broadly in a method in which a continuous transition is shaped so that the disc of a multiple-disc grinding tool, at the beginning of the grinding of the channels and while rotating, is plunge-cut, or cut into, into the glass plate vertically from above or at a specified angle.

FIGS. 11 and 12, respectively, illustrate the highest point or conjunction 94e at the upper level of rib 91, the transition 94d from the groove bottom surfaces 93 to the transition area or surface 94b, as well as the transition 94f to the peripheral area 94c.

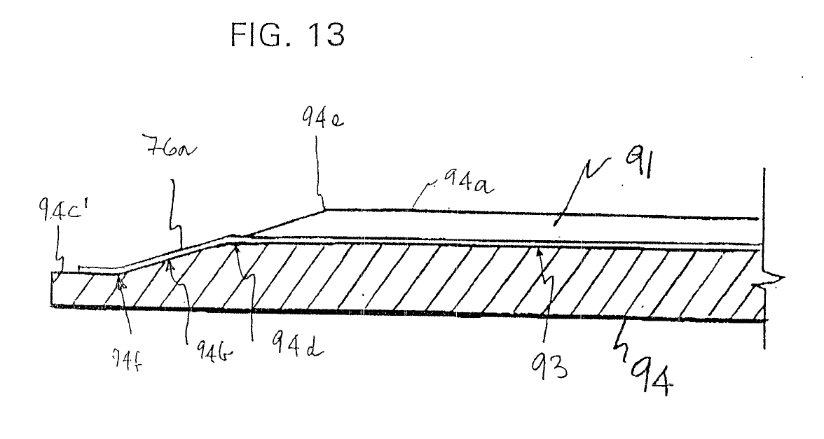

FIG. 13 illustrates an electrode being disposed on the groove bottom surface 93 and extending in smooth transition to the peripheral area 94c′.

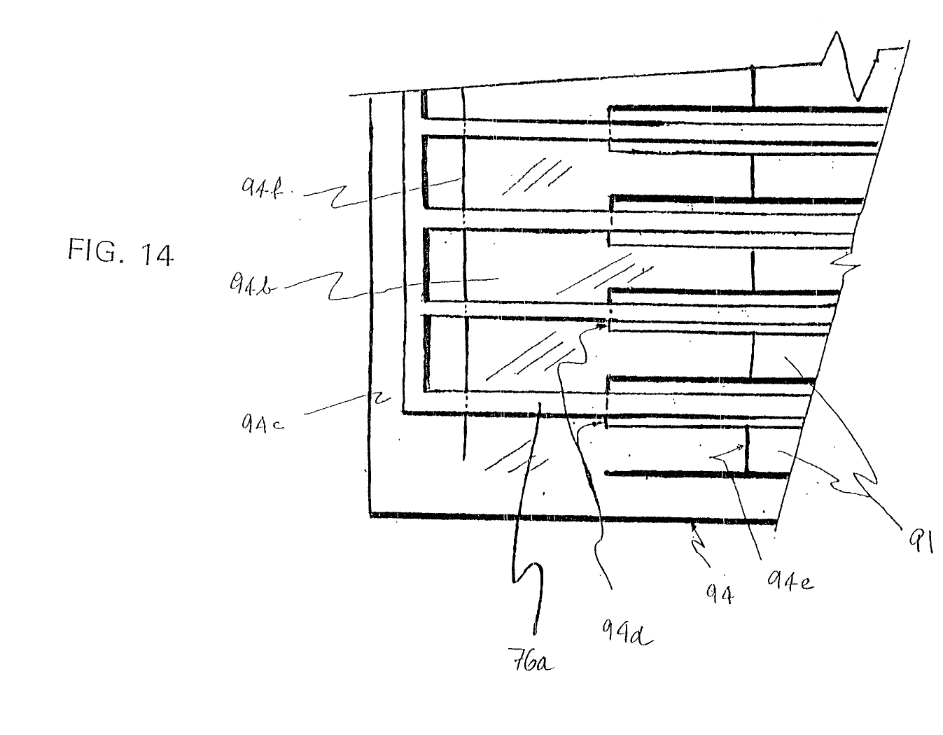

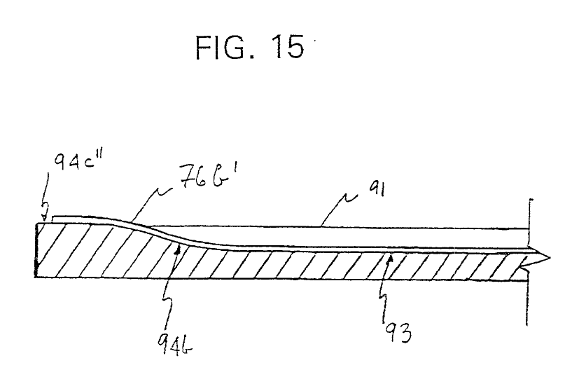

FIG. 14 illustrates a top plan view of the embodiment illustrated in FIG. 13 at an enlarged scale.

FIG. 15 illustrates an electrode 76b′ disposed on a rounded transition from the groove bottom surface 93 to the peripheral area 94c″ disposed at the level of the upper surface of a rib 91.

It will be obvious that all formations my be subjected to etching, that is, corresponding surfaces may be etched surfaces.

The electrodes may completely or partially occupy the grooves, that is may substantially occupy or cover the groove surfaces.

Further, this invention relates to a television flat panel display and a channel plate made of glass for flat panel displays such as television flat panel displays, and a method for manufacture thereof.

Display panels of flat screen displays of the type typically used in modern plasma television screens called Plasma Display Panels (PDP) or Plasma Addressed Liquid Crystal (PALC) display panels require channel plates for their operation that have high-precision microstructures in the form of a plurality of parallel microchannels that are separated by webs.

Further, in other words, modern large area or ultra-wide, flat screen displays, so-called plasma display panels (PDPs) and plasma addressed liquid displays (PALCs) require so-called channel plates of glass on which channel plate by means of webs or ribs, also known as barriers or separators, channels are formed and on which channel plate is disposed a defined amount of vertical, in the case of a PDP, or horizontal, in the case of a PALC, conductors, such as strip conductors, as address electrodes. These electrodes are provided on the glass substrate between the rib-like webs, which in turn are formed only after provision of the electrodes or prior to provision of the electrodes.

The assembly of such modern flat screen display panels, particularly of the channel plate, is described at hand of a PDP in the paper by I. H. Doyeux and J. Deschamps, “Plasma Display Panel Technology and Applications,” SID 97 DIGEST, on pages 213-217.

A section of a channel plate of this type is schematically illustrated in FIG. 8 on a greatly enlarged scale. The channel-shaped microstructures visible in this figure must be produced economically and in large numbers of units for various display sizes (diagonal screen measurements up to 60 inches and larger). Depending on the screen format, the structure dimensions are in the following ranges: web interval X=50-1000 micrometers, web height Y=50-300 micrometers and web width Z=20-100 micrometers. For a 42 inches HiVision PDP display, for example, it is necessary to fabricate approximately 5760 channels with a pitch, i.e. the interval between the webs “X”, of approximately 161 micrometers with a web height “Y” of 150 micrometers and a web width “Z” of 30 micrometers with tolerances of a few millimeters, over a length of approximately 520 millimeters. Reference to HiVision television format may be found on web page: http://www.ee.surrey.ac.uk/Contrib/WorldTV/compare.html, which web page is incorporated by reference as if set forth in its entirety herein.

Between zero and three conducting paths are applied in the form of electrodes in each of the channels between the rib-shaped webs, depending on the type of display.

In other words, strip conductors or tracks are provided in the channels between the rib-shaped webs.

Thus, this invention is concerned, in accordance with one aspect, with a channel plate made of glass for flat screen displays that has a plurality of parallel channels separated by webs, which channels are fabricated in the form of microstructures on a flat glass substrate. The invention further relates to a method for the manufacture of such a channel plate.

The structure of these modern flat screen displays, and the structure of the channel plate in particular, has been described. Various methods for the realization of the channel structure are known. In one method, the webs are laid down using the screen printing method with the formation of channels in a plurality of layers, one after the other, on a flat glass substrate. This method is very complex, time-consuming and expensive.

In another method, the channel structures are shaped in the flat glass substrate. This shaping can be done in a variety of different ways. It is to provide the generation of the channel microstructures using hot forming by embossing. There is further known the use of sandblasting via a microstructured mask to generate the channel microstructures.

Attempts have also been made to structure the channels using a grinding process. During the grinding, a high-precision multiple-disc grinding tool is used which has a plurality of precision grinding discs on a common spindle spaced axially from one another with high precision by spacer rings. Because the channels are very finely structured and are very close to one another, the manufacture of the channel plates by grinding using the multiple-disc grinding tool presents all sorts of problems, including the fact that the individual grinding discs of the multiple-disc grinding tool cannot always be located at the correct small axial distances from one another. Therefore the distance between the individual grinding discs is a whole-number multiple of the pitch “X” of the webs. Because the length of the multiple-disc grinding tool is limited by the oscillation behavior of the machining spindle and by the speed of rotation, the channel plates are fabricated using offset grinding, in which the channel plate is structured by multiple passes of the multiple-disc grinding tool. Between the individual passes, the multiple-disc grinding tool is offset at a right angle to the longitudinal axes of the channels, and specifically by the pitch to be achieved.

A method of this type using offset grinding is known.

It has been shown that on channel plates with channel structures that are ground out from a flat glass substrate, scatter, or stray or leakage radiation effects result, in particular if the channel structures have been fabricated by grinding, and especially if they are used in a PALC display, in which the channel plate is illuminated from the rear.

Thus, in accordance with one aspect of the invention, it is an object of the invention to realize a television flat screen display, or flat panel display, in which stray radiation and/or leakage radiation are minimized or attenuated to enhance picture and/or color contrast of the flat screen display.

Another object of the invention is to realize a glass channel plate described above for flat screen displays so that the stray or leakage radiation effects can be reduced, and the image and color contrast of the television picture generated on the screen can be improved.

The invention further teaches a television flat panel display, said television flat panel display comprising: a housing; a viewing screen disposed in said housing; said viewing screen comprising a first sheet; said first sheet being disposed in said housing as the front sheet of said flat panel display; a power input arrangement configured and disposed to power said flat panel display; an arrangement to produce picture elements as pixels, said arrangement at least comprising: an array of electrodes; a material configured to be energized by said electrodes to produce radiation viewable as pixels through said first sheet; and addressing circuitry connected to said array of electrodes and said power input arrangement; said addressing circuitry being configured to convert electrical signal input to said material configured to be energized into optical signal output viewable as pixels on a particular point on said first sheet of said flat panel display; and a channel member; said material to be energized to produce pixels being disposed in said channel member; apparatus to maintain said channel member and said first sheet in alignment with respect to one another; said channel member comprising a plate-like structure; said plate-like structure having a longitudinal dimension, a transverse dimension transverse to said longitudinal dimension, and a thickness; said thickness of said plate-like structure being substantially less than either said longitudinal dimension and said transverse dimension; said channel member comprising a first surface and a second surface; said first surface being configured as a substantially planar surface; said second surface being disposed substantially parallel and opposite to said first surface; said channel member comprising glass; said second surface comprising a plurality of ribs; said ribs defining a plurality of grooves extending across said longitudinal dimension and said transverse dimension of said channel member; said grooves being configured as micro structure channels being spaced apart to correspond to television pixel resolution of said television flat panel display; said grooves being configured of substantially rectangular u-shape when considered in transverse cross-section; said grooves comprising bottom surfaces extending towards said first surface; said ribs extending substantially parallel with respect to one another; said ribs having a thickness sufficient to provide mechanical stability to said ribs and their corresponding grooves; said ribs being spaced apart at a predetermined pitch to correspond to pixel resolution of said flat panel display; said ribs being configured with substantially smooth side walls; said side walls being disposed substantially perpendicularly to said first surface; said ribs comprising inner portions and outer portions; said inner portions being disposed between said first surface and said outer portions; said outer portions projecting away from said first surface; said ribs having a layer; said layer being disposed at least on said outer portions of said ribs; said layer comprising a substantially nontransparent material; said non-transparent material being configured with a sufficient optical density to minimize stray radiation and/or leakage radiation in said ribs from at least said material configured to be energized and thus in said channel member to thereby enhance picture and/or color contrast of said flat panel display.

In accordance with a further aspect of the present invention there is provided a flat panel display, said flat panel display comprising: a housing; a viewing screen disposed in said housing; said viewing screen comprising a first sheet; said first sheet being disposed in said housing as the front sheet of said flat panel display; a power input arrangement configured and disposed to power said flat panel display; an arrangement to produce picture elements as pixels on said viewing screen, said arrangement at least comprising: an array of electrodes; a material configured to be energized by said electrodes to produce radiation viewable as pixels through said viewing screen; and addressing circuitry connected to said array of electrodes and said power input arrangement; said addressing circuitry being configured to convert electrical signal input to said material to be energized into optical signal output viewable as pixels on a particular point on said first sheet of said flat panel display; and a channel member; said channel member comprising a plate-like structure; said plate-like structure having a longitudinal dimension, a transverse dimension transverse to said longitudinal dimension, and a thickness; said thickness of said plate-like structure being substantially less than either said longitudinal dimension and said transverse dimension of said plate-like structure; said channel member comprising a first surface and a second surface; said second surface being disposed opposite to said first surface; said second surface comprising a plurality of ribs; said ribs forming a plurality of grooves extending across said longitudinal dimension and said transverse dimension of said plate-like structure; said ribs extending in a predetermined pattern with respect to one another; said ribs having a thickness sufficient to provide mechanical stability to said ribs and their corresponding grooves; said ribs being spaced apart at a predetermined pitch to correspond to pixel resolution of said flat panel display; said ribs comprising inner portions and outer portions; said outer portions projecting away from said first surface; said inner portions being disposed between said first surface and said outer portions; at least said outer portions of said ribs comprising a non-transparent material configured with sufficient optical density to attenuate stray radiation and/or leakage radiation in said ribs and thus in said channel member to thereby enhance picture and/or color contrast of said flat panel display.

The invention also teaches a flat panel display, said flat panel display comprising: a housing; a viewing screen disposed in said housing; said viewing screen comprising a first sheet; said first sheet being disposed in said housing as the front sheet of said flat panel display; a power input arrangement configured and disposed to power said flat panel display; an arrangement to produce picture elements as pixels on said viewing screen, said arrangement at least comprising: an array of electrodes; a material configured to be energized by said electrodes to produce radiation viewable as pixels through said viewing screen; and addressing circuitry connected to said array of electrodes and said power input arrangement; said addressing circuitry being configured to convert electrical signal input to said material to be energized into optical signal output viewable as pixels on a particular point on said first sheet of said flat panel display; and a channel member; said channel member comprising a plate-like structure; said plate-like structure having a longitudinal dimension, a transverse dimension transverse to said longitudinal dimension, and a thickness; said thickness of said plate-like structure being substantially less than either said longitudinal dimension and said transverse dimension of said plate-like structure; said channel member comprising a first surface and a second surface; said second surface being disposed opposite to said first surface; said second surface comprising a plurality of ribs; said ribs forming a plurality of grooves extending across said longitudinal dimension and said transverse dimension of said plate-like structure; said grooves comprising bottom surfaces; said ribs extending in a predetermined pattern with respect to one another; said ribs being spaced apart at a predetermined pitch to correspond to pixel resolution of said flat panel display; said ribs comprising inner portions and outer portions; said outer portions projecting away from said first surface; said inner portions being disposed between said first surface and said outer portions; said channel member comprising at least one peripheral area being configured at the periphery of said channel member and to support at least portions of said electrodes; and a transition area being disposed between said groove bottom surfaces and said at least one peripheral area; said transition area being configured substantially without a step; said electrodes being disposed in said transition area in a substantially stepless transition from said groove bottom surfaces to said at least one peripheral area.

In accordance with another aspect, the invention teaches that these objects can be accomplished, on a glass channel plate for flat screen displays which has a number of parallel channels separated by webs, which channels are fabricated on a flat glass substrate, at least the upper edge of the webs is covered by a non-transparent coating.

In other words, a plurality of ribs is structured on a glass substrate. Also in other words, the fabrication of the channels may be, for example, by grinding.

The covering of the upper edge of the web or rib prevents the exit of scattered and other leakage radiation and thereby increases the image and color contrast.

In a first refinement of the invention, the channel plate is realized so that the non-transparent coating has a thickness that is significantly less than the depth of the channels, and the channel structures are fabricated in the glass substrate.

In one configuration of the invention, the channel structures are preferably ground out through the non-transparent coating.

Alternatively, in a second configuration of the invention, the channel plate can be realized so that the thickness of the non-transparent coating is at least equal to the specified depth of the channels and the channel structures are ground out from the non-transparent coating. Here, too, in one configuration, the channel structures are preferably ground in the non-transparent coating. This second configuration of the invention has an advantageous effect on the tool wear and the advance speed during the fabrication of the channel structures.

With regard to the method for the manufacture of the channel plate, the solution taught by the invention includes the following steps:

Preparation of a flat, rectangular glass plate with specified dimensions,

Application of a non-transparent coating at a specified thickness on one side of the glass plate, and structuring of the channels through the non-transparent coating in the glass substrate or exclusively in the non-transparent coating with the appropriate thickness.

In one configuration of the invention, the channels are structured by grinding the channels by means of a high-precision multiple-disc grinding tool by offset grinding.

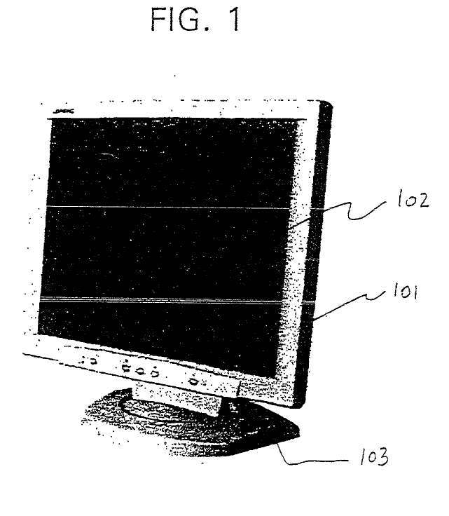

FIG. 1 shows a perspective view from the front of a television flat panel display with a housing 101 for a display panel or screen 102. The housing can be supported by a base 103.

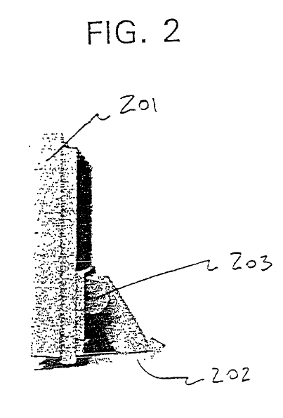

FIG. 2 is a perspective view from the side of a television flat panel display showing a housing 201 and a base 202. The angular attitude of this display can be changed by a pivot arrangement.

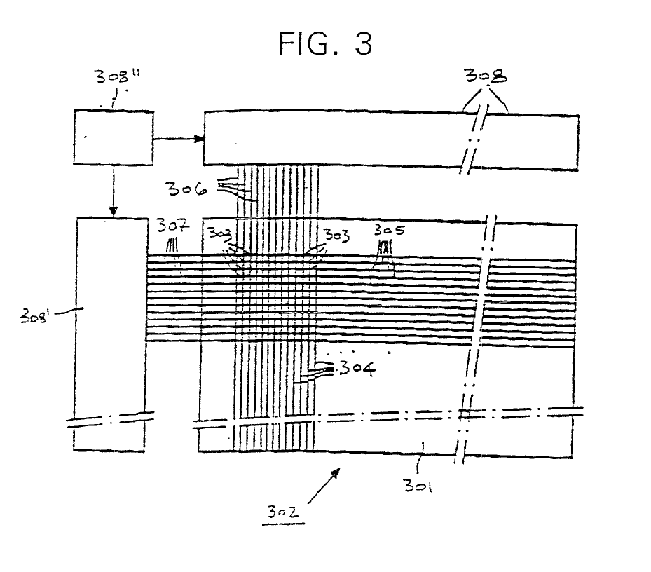

Referring now to FIG. 3, this figure is a copy of FIG. 1 from U.S. Pat. No. 6,052,160 issued to Bohmer et al. on Apr. 18, 2000, from which figure copy all of the reference numerals present in the original figure, as it appears in U.S. Pat. No. 6,052,160 have been removed. U.S. Pat. No. 6,052,160 is hereby incorporated by reference as if set forth in its entirety herein. The reference numerals that have been removed from the FIG. 1 for this U.S. Pat. No. 6,052,160, essentially reproduced herein as FIG. 3 with new reference numerals, indicate arrangements that are well known in the prior art.

Thus, FIG. 3 very schematically shows a block diagram of a display device. Said display device comprises a substrate 301 having a surface 302 provided with a pattern of pixels separated from each other in the vertical and horizontal directions; the space between the pixels being predetermined. Each pixel 303 comprises overlapping portions of thin, narrow electrodes 304 of a group of electrodes arranged in vertical columns and thin, narrow electrodes 305 of a further group of electrodes arranged in horizontal rows. The electrodes 304 of the group of electrodes are also referred to as column electrodes, and the electrodes 305 of the further group of electrodes are also referred to as row electrodes. In a plasma addressed liquid crystal display device (PALC), the rows are formed by long, narrow channels, the compartments. The pixels 303 in each of the rows of electrodes 305 disposed in channels represent one data line.

The width of the electrodes 304 and 305 determines the dimensions of the pixels 303, which are typically rectangular in shape. Electrodes 304 receive drive signals, for example, analog dive signals, “data drive signals”, from a drive circuit 308 via parallel conductors 306, and electrodes 305 receive drive signals, for example analog drive signals, “data drive signals,” from a drive circuit 308′ via parallel conductors 307.

To produce an image or a data-graphic display on a relevant area of the surface 302 of substrate 301, the display device employs a control circuit 308″ also referred to as “scan control circuit”, which controls the drive circuits 308, 308′. In the display device, various types of electro-optical materials may be used. Examples of electro-optical materials include nematic, for example, twisted nematic, or ferro-electric liquid crystal materials. In general, the electro-optical materials weaken the passed or reflected light in dependence upon a voltage applied across the material.

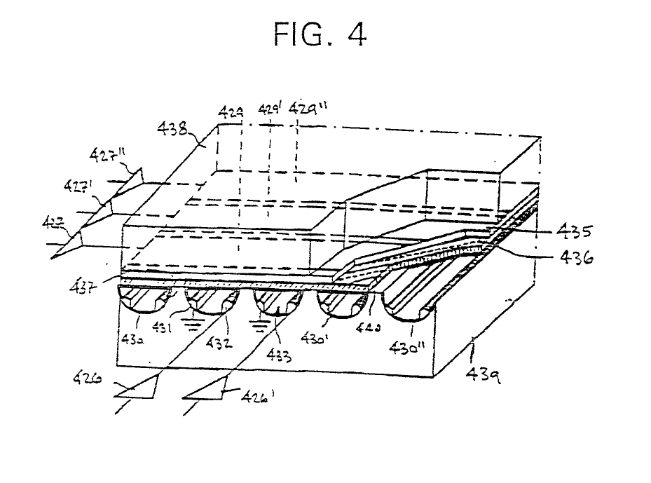

Referring now to FIG. 4, this figure is a copy of FIG. 2 from U.S. Pat. No. 6,052,160 mentioned in the foregoing, from which figure copy all of the reference numerals present in the original figure, as it appears in U.S. Pat. No. 6,052,160, have been removed. The reference numerals that have been removed from the FIG. 2 for this U.S. Pat. No. 6,052,160, essentially reproduced herein as FIG. 4 with new reference numerals, indicate arrangements that are well known in the prior art.

Thus, FIG. 4 shows a perspective view, partly cut away, of a part of a construction of a plasma addressed liquid crystal display device (PALC) comprising a first substrate 438 and a second substrate 439. In FIG. 4, only three column electrodes 429, 429′, 429″ are shown. The row electrodes 430, 430′, 430″, which serve as selection means, are formed by a number of mutually parallel, elongated channels, or compartments, below an electro-optical layer 435 of an electro-optical material. The panel is provided with electric connections to the column electrodes 429, 429′, 429″ and to the plasma electrodes 431, 432, said column electrodes 429, 429′, 429″ receiving drive signals, for example, analog drive signals, from output amplifiers 427, 427′, 427″, and the anode electrodes 432 in the channels containing plasma 430, 430′, 430″ receiving drive signals from output amplifiers 426, 426′. Each of the plasma channels 430, 430′, 430″ is filled with an ionizable gas 433 and is sealed with a thin dielectric layer, also referred to as “microsheet”, 436 which is made, for example, of glass. Each of the compartments, i.e, the channels is provided at an inner surface wall with first and second elongated electrodes 431, 432 extending throughout the length of the channel. The second electrode 432 is referred to as the anode and is supplied with a pulsed voltage, a so-called “strobe pulse”, causing electrons emitted from the cathode 431 to ionize the gas, thereby forming a plasma. In an alternative embodiment, a negative, for example, direct-current, pulse is applied to the cathode. The next channel is not energized until after the “strobe pulse” has ended and the gas has been deionized. To reduce the duration of the cycle, the next channel is generally ionized already before the preceding channel has been substantially completely de-ionized. The column electrodes 429, 429′, 429″ each cross an entire column of pixels, so that, in order to preclude crosstalk, the number of plasma row connections per unit of time is limited to only one.

In accordance with the proposal of FIG. 4, at least one of the electrodes 431, 432 is furnished with an electro-conductive layer 437 of microscopic particles of a sputter-resistant material, for example, refractory material, having an average particle diameter below 2.5 micrometers (d₅₀ equal to or less than 2.5 micrometers). The layer 437 is preferably provided by means of electrophoresis. By employing particles having an average diameter below 2.5 micrometers, the desired conductivity of the conductive layer 437 is achieved without the necessity of adding a glass frit to the layer. By virtue of the absence of the glass frit, such a layer has a higher secondary electron-emission coefficient, which causes the ignition and sustain voltages and hence the energy consumption of the display device to be reduced considerably. In a layer 437 which is applied to the electrodes 431, 432 in the plasma channels 430, 430′, 430″ of the display device and which includes particles having a diameter in accordance with the embodiment illustrated in FIG. 4, anode spots do not occur. In addition, the improved conductivity of the sputter-resistant material enables the electro-optical layer to be better addressed. By virtue of the relatively small particles, the layer 437 is generally thinner, resulting in a lower aperture loss in the display device. Preferably, the average diameter of the particles in the layer 437 is below 1.5 micrometers (d₅₀ is equal to or less than 1.5 micrometers), with d₉₀ being equal to or less than 2.4 micrometers. Suitable materials include rare-earth borides, for example, LaB₆ or GdB₆, or ruthenium oxide (RuO₂). Other suitable materials include Cr₃Si, diamond, diamond-like carbon and barium tantalate (Ba₄Ta₂O₉).

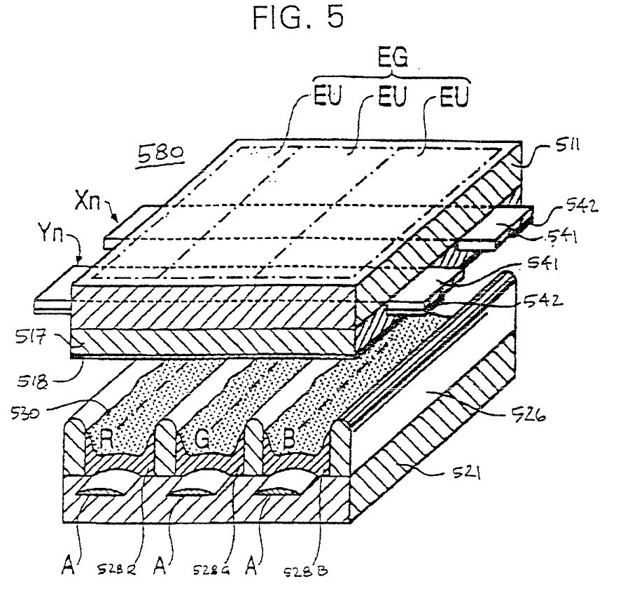

Referring now to FIG. 5, this figure is a copy of FIG. 1 from U.S. Pat. No. 5,967,872 issued to Betsui et al. on Oct. 19, 1999, from which figure copy all of the reference numerals present in the original figure, as it appears in U.S. Pat. No. 5,967,872 have been removed. U.S. Pat. No. 5,967,872 is hereby incorporated by reference as if set forth in its entirety herein. The reference numerals that have been removed from the FIG. 1 for this U.S. Pat. No. 5,967,872, essentially reproduced herein as FIG. 5 with new reference numerals, indicate arrangements that are well known.

Thus, FIG. 5 illustrates an exploded, perspective view of a known PDP 580, where is shown the structure of a part which corresponds to a single picture element, i.e. a pixel, EG. In this PDP 580, each of pixels EG which compose the screen is formed of three sub-pixels EU of R. i.e. red, G. i.e. green and B, i.e. blue, aligned on a line. That is, this arrangement form of the three colors for the color display is a so-called in-line type.

As illustrated herein in FIG. 5, the PDP 580 is an AC type PDP of the surface discharge type for allowing the color display, and is composed of front and back glass substrates 511 and 521, a pair of first and second display electrodes Xn and Yn, a dielectric layer 517, a protection film 51, a back glass substrate 521, address electrodes A, separator walls 526, which may be referred to as a separator rib, or a barrier rib, fluorescent layers 528R, 528G and 528B, and a discharge gas enclosed in a discharge space 530 between the front and back glass substrates 511 and 521. Each of first and second display electrodes Xn and Yn is formed of a transparent electrode 541 of a relatively large width and a relatively narrow width metal electrode 542, which may be referred to as a bus electrode, for supplementing the electrical conductivity of the transparent electrode 541. First and second display electrodes Xn and Yn, in a pair, provide a line. Address electrode A extends along a row direction, orthogonal to the line direction, to cross the display electrodes Xn and Yn, and a voltage applied there between causes a discharge with respect to the second display electrode Yn in order to control wall charges upon dielectric layer 517 at the crossing point. Separator walls 526 are straight and parallel when looked down thereat, and are arranged with an equal space measured in the extending direction of display electrodes Xn and Yn, that is, measured in the line direction of the display screen. Discharge space 530 is thus divided by the plural separator walls 526 so as to provide a channel there between for each unit display element EU, which is referred to hereinafter as a sub-pixel, divided in the line direction. The height of discharge space 530 is uniform throughout the display area. Upon an application of a predetermined voltage to between the first and second display electrodes Xn and Yn in pair, an electric discharge takes place there between along the surface of dielectric layer 517 at a sub-pixel which has been addressed in the address period, so that fluorescent layer 528R, 528G or 528B in the addressed sub-pixel is excited to emit a light by an ultraviolet ray emitted from the discharge gas.

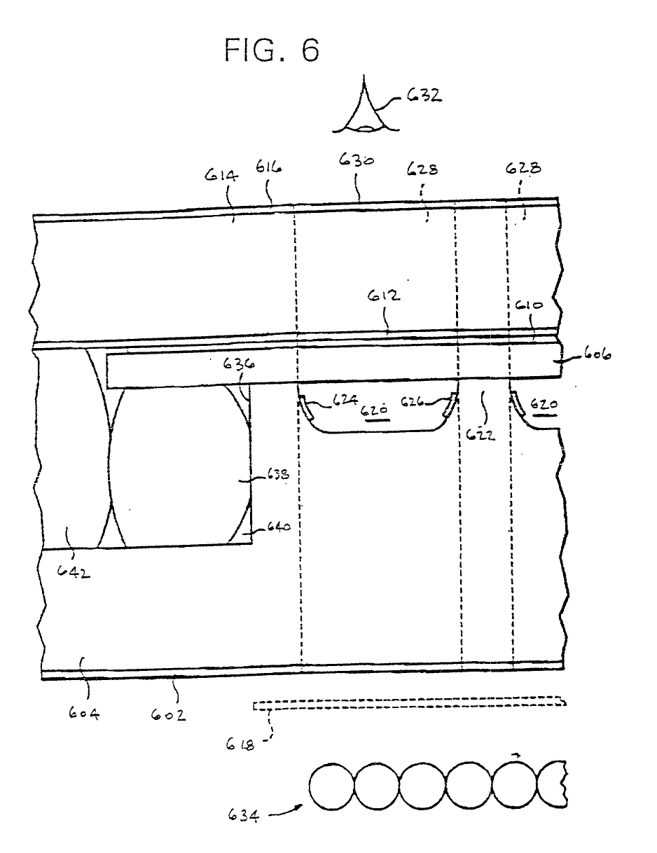

Referring now to FIG. 6, this figure is a copy of FIG. 1 from U.S. Pat. No. 6,153,979 issued to Ilcisin et al. on Nov. 28, 2000, from which figure copy all of the reference numerals present in the original figure, as it appears in U.S. Pat. No. 6,153,979 have been removed. U.S. Pat. No. 6,153,979 is hereby incorporated by reference as if set forth in its entirety herein. The reference numerals that have been removed from the FIG. 1 for this U.S. Pat. No. 6,153,979, essentially reproduced herein as FIG. 6 with new reference numerals, indicate arrangements that are well known in the prior art.

Thus, FIG. 6 illustrates a display panel or panel display which comprises, in sequence from below, a polarizer 602, a channel member 604, a cover sheet 606, commonly known as a microsheet, a layer 610 of electro-optic material, an array of parallel transparent data drive electrodes, only one of which, designated 612, can be seen in the view shown in FIG. 6, an upper substrate 614 carrying the data drive electrodes, and an upper polarizer 616. In the case of a color display panel, the panel includes color filters (not shown) between the layer 610 and the upper substrate 614. The panel may also include layers for improving viewing angle and for other purposes. The channel member 604 is typically made of glass and is formed with multiple parallel channels 620 in its upper main face. The channels 620, which are separated by ribs 622, are filled with an ionizable gas, such as helium. An anode 624 and a cathode 626 are provided in each of the channels 620. The channels 620 are orthogonal to the data drive electrodes and the region where a data drive electrode crosses a channel, when viewed perpendicularly to the panel, forms a discrete panel element 628. Each panel element can be considered to include elements of the layer 610 and the lower and upper polarizers 602 and 616. The region of the upper surface of the display panel that bounds the panel element constitutes a single pixel or picture element 630 of the display panel.

When the anode 624 in one of the channels is connected to a reference potential and a suitably more negative voltage is applied to the cathode 626 in that channel, the gas in the channel forms a plasma which provides a conductive path to the reference potential at the lower surface of the cover sheet 606. If a data drive electrode is at the reference potential, there is no significant electric field in the volume element of electro-optic material in the panel element at the crossing of the channel and the data drive electrode and the panel element is considered to be off, whereas if the data drive electrode is at a substantially different potential from the reference potential, there is a substantial electric field in that volume element of electro-optic material and the panel element is considered to be on.

It will be assumed in the following description, without intending to limit the scope of the invention as claimed herein, that the lower polarizer 602 is a linear polarizer and that its plane of polarization can be arbitrarily designated as being at zero degrees relative to a reference plane, that the upper polarizer 616 is a linear polarizer having its plane of polarization at 90 degrees, and that the electro-optic material rotates the plane of polarization of linearly polarized light passing therethrough by an angle which is a function of the electric field in the electro-optic material. When the panel element is off, the angle of rotation is 90 degrees; and when the panel element is on, the angle of rotation is zero.

The panel is illuminated from the underside by an extended light source 634 which emits unpolarized white light. A rear glass diffuser 618 having a scattering surface may be positioned between the light source and the panel in order to provide uniform illumination of the panel. The light that enters a given panel element from the source is linearly polarized at zero degrees by the lower polarizer 602 and passes sequentially through the channel member 604, the channel 620, the cover sheet 606, and the volume element of the electro-optic material toward the upper polarizer 616 and a viewer 632. If the panel element is off, the plane of polarization of linearly polarized light passing through the volume element of electro-optic material is rotated through 90 degrees, and therefore the plane of polarization of light incident on the upper polarizer element is at 90 degrees. The light is passed by the upper polarizer element and the pixel is illuminated. If, on the other hand, the panel element is on, the plane of polarization of the linearly polarized light is not changed on passing through the volume element of electro-optic material. The plane of polarization of light incident on the upper polarizer element is at zero degrees and therefore the light is blocked by the upper polarizer element and the pixel is dark. If the electric field in the volume element of electro-optic material is intermediate the values associated with the panel element being off and on, light is passed by the upper polarizer element with an intensity which depends on the electric field, allowing a gray scale to be displayed.

In a practical implementation of a PALC display panel, the channel member 604 is etched back around the area in which the channels are formed in order to provide a plateau 636 in which the channels 620 are formed, and the cover sheet 606 is secured to the channel member by an endless frit bead 638 in a rabbet 640 extending around the periphery of the plateau. An upper substrate assembly, including the upper substrate 614 and the data drive electrodes 612 carried thereby, is attached to the channel member 604 by means of a glue bead 642.

FIG. 10 is an enlarged and greatly simplified illustration of the structure of the prior art of a channel plate for modern flat screen displays. This channel plate has a plurality of parallel channels 72 that are separated by webs 71. Zero to three electrodes are attached to the bases 73 of the channels, depending on the type and model of the display.

The manufacture of a glass plate of this type provided with the characteristics claimed by the invention is performed in the following steps:

First, a flat, rectangular glass plate 74, the glass substrate, is prepared with specified dimensions that correspond to the required screen size. This glass plate is preferably manufactured by floating or drawing and is preferably made of borosilicate glass.

Glass plates manufactured in this manner typically have wave-shaped irregularities with a long wavelength on their surfaces called “warp”, and a waviness with a very short wavelength. The warp and the waviness can be minimized by flat grinding, for example, surface grinding, of one or both sides of the glass surface in the next optional step, with a resulting reduction of the tolerance range of the structured channel plate. When a suitable grinding disc is used, the flat-ground, for example, surface-ground, glass surface minimizes undesirable leakage radiation and thus increases contrast when the channel plate is used in a PALC display.

The glass plate 74 is then provided with a non-transparent cover layer 75, for example by screen printing (Step 1 in FIG. 9). The material for the covering can thereby be a glass solder, a screen printing ink, a plastic or a metal. In other words, there may be applied a layer or coating comprised of glass solder, or, in other words, a sealing glass, a screen printing ink, a plastic, or a metal, so as to provide a non-transparent phase which may be opaque, translucent or pigmented.

The channels are then ground in Step 2 shown in FIG. 9.

The channels 72 in the flat-ground, such as, for example, surface-ground, glass plate 74 covered by the coating 75 are structured with one of the methods described above, preferably by grinding the channels using a high-precision multiple-disc grinding tool.

High-precision multiple-disc grinding nodules of this type typically have a plurality of precision grinding discs mounted on a common spindle and kept at a precise axial distance from one another by spacer rings, for the simultaneous grinding of parallel microstructures in a workpiece. The grinding discs must thereby be at a highly precise distance from one another with very small tolerances. For the reasons indicated above, the channel structure is thereby created by the offset grinding method described above.

The covering of the upper edge of the web by the coating 5 prevents the exit of leakage radiation or stray radiation through the upper side of the web, and thus contributes to improving the image and contrast of the television picture.

There are a number of different possibilities to deposit and control the thickness of this covering 75.

In the case illustrated in FIG. 9, for example, the thickness of the coating 75 is in the range of 10 micrometers to 1 millimeter.

Another possibility is to configure the cover so thick that the channels are structured only in the cover layer (e.g. structuring in glass solder), which is significantly easier to work. There are significant advantages to this method during grinding, in particular with regard to tool wear and the advance speeds possible.

To optimize the topography of the ground glass surface, the channels 72 can be refined, or fined, after the structuring (Step 2). This refining can be realized by etching, for example, and is intended primarily to increase contrast and to relieve stresses in the glass, i.e. to improve the mechanical stability of the webs or ribs 71. The surface quality on the channel bases and the polarization properties of the ground surfaces can be improved so that the characteristics of the channel plate can be adapted as appropriate to its intended use.

Another possible method of increasing contrast is to introduce the electrodes 76 into the structured channels 72. The introduced electrodes 76 are thereby used only to actuate the plasma cells, but as a result of their non-transparency have the advantage that they minimize undesirable leakage radiation and thus make a significant contribution to improving the contrast. Locating the electrodes in the corners of the channels (FIG. 9), for example, can prevent undesirable leakage radiation which occurs as a result of the unavoidable radii on the base of the channels.

One feature of the invention resides broadly in a channel plate made of glass for flat screen displays which has a plurality of parallel channels 72 separated by webs 71, which channels are fabricated in the form of microstructures on a flat glass substrate 74, characterized by the fact that at least the upper edge of the webs 71 is covered by a non-transparent coating 75.

Another feature of the invention resides broadly in a channel plate characterized by the fact that the non-transparent coating 75 has a thickness that is significantly less than the depth of the channels 72 and the channel structures are fabricated, or ground, in the glass substrate 74.

Yet another feature of the invention resides broadly in a channel plate characterized by the fact that the channel structures are ground through the non-transparent coating 75 into the glass substrate 74.

Still another feature of the invention resides in a channel plate characterized by the fact that the thickness of the nontransparent coating 75 is at least equal to the specified depth of the channels and the channel structures are fabricated, or ground, in the non-transparent coating 75.

A further feature of the invention resides broadly in a channel plate characterized by the fact that the channel structures are ground in the non-transparent coating 75.

Another feature of the invention resides broadly in a channel plate characterized by the fact that the non-transparent coating 75 consists of a glass solder or a screen printing ink, a plastic or a metal.

Yet another feature of the invention resides in a channel plate in which electrodes 76 are deposited at an angle in the channels 72, with one leg on the channel bottom and the other leg on the neighboring web wall.

Still another feature of the invention resides broadly in a channel plate in which the channels are chemically refined to increase contrast and to relieve stresses.

A further feature of the invention resides broadly in a method for the manufacture of a channel plate comprising the following steps:

Preparation of a flat, rectangular glass plate with specified dimensions,

Application of a non-transparent coating at a specified thickness on one side of the glass plate, and

Structuring of the channels through the non-transparent coating in the glass substrate, or only in the non-transparent coating that has a corresponding thickness.

Another feature of the invention resides broadly in a method in which the structuring of the channels is done by grinding the channels by means of a high-precision multiple-disc grinding tool by offset grinding.

Yet another feature of the invention resides in a method in which the material for the covering is a glass solder, screen printing ink, plastic or metal.

Still another feature of the invention resides broadly in a method in which the channels are chemically refined after their structuring to increase contrast and to relieve stresses.

Channel plates as described herein typically have a plurality of parallel channels 72 separated by webs 71, which channels 72 are fabricated in the form of microstructures on a flat glass plate 74. The channels 72 can be ground using a high-precision multiple-disc grinding tool, for example, into the flat rectangular glass plate 74, which has preferably been subjected to a high-precision surface grinding at least on the side on which the channel structure is machined. To improve the image and color contrast of the image generated on the flat screen display, at least the upper edges of the webs 71 are covered by a non-transparent coating 75.

The terms flat panel display and flat screen display may be used to describe a television monitor of flat configuration, or the like monitor.

The components disclosed in the various publications, disclosed or incorporated by reference herein, may be used in the embodiments of the present invention, as well as equivalents thereof.

The appended drawings in their entirety, including all dimensions, proportions and/or shapes in at least one embodiment of the invention, are accurate and are hereby included by reference into this specification.

All, or substantially all, of the components and methods of the various embodiments may be used with at least one embodiment or all of the embodiments, if more than one embodiment is described herein.

All of the patents, patent applications and publications recited herein, and in the Declaration attached hereto, are hereby incorporated by reference as if set forth in their entirety herein.

The corresponding foreign patent publication applications, namely, Federal Republic of Germany Patent Application No. 100 26 974.5-33, filed on May 31, 2000, having inventors Dr. Markus VOS, Dipl.-Ing. Sven PALLHORN, Dipl.-Ing. Patrick W. JULIUS, Dr. Marten WALTHER, Dr. Tobias KÄLBER, and Dr. Thomas KESSLER, entitled, “Kanalplatte aus Glas für Flachbildschirme und Verfahren zu ihrer Herstellung,” and DE-OS 100 26 974 and DE-PS 100 26 974, as well as their published equivalents, and other equivalents or corresponding applications, if any, in corresponding cases in the Federal Republic of Germany and elsewhere, and the references and documents cited in any of the documents cited herein, such as the patents, patent applications and publications, are hereby incorporated by reference as if set forth in their entirety herein. All the patents, patent applications and publications anywhere in the present application, such as the references and documents cited in any of the documents cited herein are hereby incorporated by reference as if set forth in their entirety herein.

Another foreign patent publication application, namely, Federal Republic of Germany Patent Application No. 100 00 836.445, filed on Jan. 12, 2000, having inventors Dr. Ulrich PEUCHERT and Dr. Peter BRIX, entitled, “Alkalifreies Aluminoborosilicatglas und dessen Verwendung,” and DE-OS 100 00 836.4-45 and DE-PS 100 00 836.4-45, as well as their published equivalents, and other equivalents or corresponding applications, if any, in corresponding cases in the Federal Republic of Germany and elsewhere, and the references cited in any of the documents cited herein, are hereby incorporated by reference as if set forth in their entirety herein.

Another foreign patent publication application, namely, Federal Republic of Germany Patent Application No. 100 00 838.045, filed on Jan. 12, 2000, having inventors Dr. Ulrich PEUCHERT and Dr. Peter BRIX, entitled, “Alkalifreies Aluminoborosilicatglas und dessen Verwendung,” and DE-OS 100 00 838.0-45 and DE-PS 100 00 838.0-45, as well as their published equivalents, and other equivalents or corresponding applications, if any, in corresponding cases in the Federal Republic of Germany and elsewhere, and the references cited in any of the documents cited herein, are hereby incorporated by reference as if set forth in their entirety herein.

Another foreign patent publication application, namely, Federal Republic of Germany Patent Application No. 100 00 839.945, filed on Jan. 12, 2000, having inventors Dr. Ulrich PEUCHERT and Dr. Peter BRIX, entitled, “Alkalifreies Aluminoborosilicatglas und dessen Verwendung,” and DE-OS 100 00 839.9-45 and DE-PS 100 00 839.9-45, as well as their published equivalents, and other equivalents or corresponding applications, if any, in corresponding cases in the Federal Republic of Germany and elsewhere, and the references cited in any of the documents cited herein, are hereby incorporated by reference as if set forth in their entirety herein.

Another foreign patent publication application, namely, Federal Republic of Germany Patent Application No. 100 00 837.245, filed on Jan. 12, 2000, having inventors Dr. Ulrich PEUCHERT and Dr. Peter BRIX, entitled, “Alkalifreies Aluminoborosilicatglas und dessen Verwendung,” and DE-OS 100 00 837.2-45 and DE-PS 100 00 837.2-45, as well as their published equivalents, and other equivalents or corresponding applications, if any, in corresponding cases in the Federal Republic of Germany and elsewhere, and the references cited in any of the documents cited herein, are hereby incorporated by reference as if set forth in their entirety herein.

Another foreign patent publication application, namely, Federal Republic of Germany Patent Application No. 100 26 976.145, filed on May 31, 2000, having inventors Dr. Markus VOS, Dipl.-Ing. Sven PALLHORN, Dipl.-Ing. Patrick W. JULIUS, Dr. Marten WALTHER, Dr. Tobias KÄLBER, and Dr. Thomas KESSLER, entitled, “Kanalplatte aus Glas für Flachbildschirme und Verfahren zu ihrer Herstellung,” and DE-OS 100 26 976.1-45 and DE-PS 100 26 976.1-45, as well as their published equivalents, and other equivalents or corresponding applications, if any, in corresponding cases in the Federal Republic of Germany and elsewhere, and the references cited in any of the documents cited herein, are hereby incorporated by reference as if set forth in their entirety herein.

The details in the patents, patent applications and publications may be considered to be incorporable, at Applicants' option, into the claims during prosecution as further limitations in the claims to patentably distinguish any amended claims from any applied prior art.

The following U.S. Patent application is to be incorporated by reference as follows: U.S. patent application Ser. No.09/758919, having attorney docket No. NHL-SCT-18 US, filed on Jan. 11, 2001, entitled, “ALKALI-FREE ALUMINOBOROSILICATE GLASS, AND USES THEREOF,” having inventors Dr. Ulrich PEUCHERT and Dr. Peter BRIX, is hereby incorporated by reference as if set forth in its entirety herein.

The following U.S. Patent application is to be incorporated by reference as follows: U.S. patent application Ser. No.09/758952, having attorney docket No. NHL-SCT-19 US, filed on Jan. 11, 2001, entitled, “ALKALI-FREE ALUMINOBOROSILICATE GLASS, AND USES THEREOF,” having inventors Dr. Ulrich PEUCHERT and Dr. Peter BRIX, is hereby incorporated by reference as if set forth in its entirety herein.

The following U.S. Patent application is to be incorporated by reference as follows: U.S. patent application Ser. No.09/758946, having attorney docket No. NHL-SCT-20 US, filed on Jan. 11, 2001, entitled, “ALKALI-FREE ALUMINOBOROSILICATE GLASS, AND USES THEREOF,” having inventors Dr. Ulrich PEUCHERT and Dr. Peter BRIX, is hereby incorporated by reference as if set forth in its entirety herein.

The following U.S. Patent application is to be incorporated by reference as follows: U.S. patent application Ser. No.09/758903, having attorney docket No. NHL-SCT-21 US, filed on Jan. 11, 2001, entitled, “ALKALI-FREE ALUMINOBOROSILICATE GLASS, AND USES THEREOF,” having inventors Dr. Ulrich PEUCHERT and Dr. Peter BRIX, is hereby incorporated by reference as if set forth in its entirety herein.

The following U.S. Patent application is to be incorporated by reference as follows: U.S. patent application Ser. No. ______, having attorney docket No. NHL-FMW-05 US(SCT), filed on May 29, 2001, entitled, “TELEVISION FLAT PANEL DISPLAY AND CHANNEL PLATE MADE OF GLASS FOR FLAT PANEL DISPLAYS SUCH AS TELEVISION FLAT PANEL DISPLAYS AND METHOD FOR MANUFACTURE,” having inventors Dr. Markus VOS, Dipl.-Ing. Sven PALLHORN, Dipl.-Ing. Patrick W. JULIUS, Dr. Marten WALTHER, Dr. Tobias KÄLBER, and Dr. Thomas KESSLER, is hereby incorporated by reference as if set forth in its entirety herein.

Some examples of plasma display panels (PDP) which may be utilized or adapted for use in at least one possible embodiment of the present invention or in which the present invention may possibly have application, may be found in the following U.S. Pat. No. 4,185,229 issued on Jan. 22, 1980 to Yoshikawa et al. and entitled, “Gas discharge panel,” U.S. Pat. No. 4,276,492 issued on Jun. 30, 1981 to Mayer and entitled, “Plasma display panel,” U.S. Pat. No. 4,359,663 issued on Nov. 16, 1982 to Shinoda et al. and entitled, “Gas discharge panel having plurality of shift electrodes,” U.S. Pat. No. 5,844,373 issued on Dec. 1, 1998 to Yao et al. and entitled, “Power supplying apparatus, a plasma display unit, a method of converting a direct-current voltage and a method of adding two direct-current voltages,” U.S. Pat. No. 5,967,872 issued on Oct. 19, 1999 to Betsui et al. and entitled, “Method for fabrication of a plasma display panel,” U.S. Pat. No. 6,057,815 issued on May 2, 2000 to Sano and entitled, “Driver circuit for ACmemory plasma display panel,” U.S. Pat. No. 6,078,205 issued on Jun. 20, 2000 to Ohsawa et al. and entitled, “Circuit device, drive circuit, and display apparatus including these components,” U.S. Pat. No. 6,160,348 issued on Dec. 12, 2000 to Choi and entitled, “DC plasma display panel, and methods for making same,” U.S. Pat. No. 6,160,530 issued on Dec. 12, 2000 to Makino and entitled, “Method and device for driving a plasma display panel,” No. RE37,083 E issued on Mar. 6, 2001 to Kanazawa and entitled, “Method and apparatus for driving surface discharge plasma display panel,” and U.S. Pat. No. 6,198,222 B1 issued on Mar. 6, 2001 to Chang and entitled, “Plasma display device with heat dissipation channels.” The aforementioned patents and the references contained therein are hereby incorporated by reference as if set forth in their entirety herein.

Some examples of plasma addressed liquid crystal (PALC) display panels which may be utilized or adapted for use in at least one possible embodiment of the present invention or in which the present invention may possibly have application, may be found in the following U.S. Pat. No. 5,077,553 issued on Dec. 31, 1991 to Buzak and entitled, “Apparatus for and methods of addressing data storage elements,” U.S. Pat. No. 5,499,122 issued on Mar. 12, 1996 to Yano and entitled, “Plasma-addressed liquid crystal display device having a transparent dielectric sheet with a porous layer containing an impregnated liquid crystal,” U.S. Pat. No. 5,526,151 issued on Jun. 11, 1996 to Miyazaki et al. and entitled, “Method of manufacturing a plasma addressed liquid crystal display device having planarized barrier ribs,” U.S. Pat. No. 5,694,183 issued on Dec. 2, 1997 to Ilcisin et al. and entitled, “Plasma addressed liquid crystal display panel with internal polarizer,” U.S. Pat. No. 5,754,003 issued on May 19, 1998 to Murai et al. and entitled, “Discharger display device having means for air-tight separation of discharge chambers by partition walls, and process of producing the same,” U.S. Pat. No. 5,757,342 issued on May 26, 1998 to Hayashi and entitled, “Plasma addressed liquid crystal display device,” U.S. Pat. No. 5,810,634 issued on Sep. 22, 1998 to Miyazaki et al. and entitled, “Method of manufacturing a plasma addressed liquid crystal display device,” U.S. Pat. No. 5,844, 639 issued on Dec. 1, 1998 to Togawa and entitled, “Plasma addressed liquid crystal display device, ” U.S. Pat. No. 5,868,811 issued on Feb. 9, 1999 to Khan et al. and entitled, “Method of making a channel plate for a flat display device,” U.S. Pat. No. 5,903,325 issued on May 11, 1999 to Ilcisin et al. and entitled,“Plasma addressed liquid crystal display panel with optimized relationship between liquid crystal parameters and cover sheet thickness,” U.S. Pat. No. 5,917,463 issued on Jun. 29, 1999 to Ilcisin et al. and entitled, “Plasma addressed liquid crystal display panel with thinned cover sheet,” U.S. Pat. No. 5,948,228 issued on Sep. 7, 1999 to Hinchliffe et al. and entitled, “Method of fabricating a channel member for a PALC display panel,” U.S. Pat. No. 5,990,619 issued on Nov. 23, 1999 to Ilcisin et al. and entitled, “Electrode structures for plasma addressed liquid crystal display devices,” U.S. Pat. No. 6,002,456 issued on Dec. 14, 1999 to Togawa and entitled, “Plasma addressed liquid crystal display apparatus,” U.S. Pat. No. 6,027,661 issued on Feb. 22, 2000 to Ilcisin et al. and entitled, “Method of fabricating a channel substrate for a PALC display panel,” U.S. Pat. No. 6,057,895 issued on May 2, 2000 to Van Helleputte et al. and entitled, “Plasma addressed liquid crystal display with deposited plasma channels with tapered edges,” U.S. Pat. No. 6,064,153 issued on May 16, 2000 to Ilcisin et al. and entitled, “Channel subassembly for a plasma addressed liquid crystal display panel,” U.S. Pat. No. 6,081,245 issued on Jun. 27, 2000 to Abe and entitled, “Plasma-addressed liquid crystal display device,” U.S. Pat. No. 6,094,183 issued on Jul. 25, 2000 to Tanamachi et al. and entitled, “Plasma addressed liquid crystal display device,” U.S. Pat. No. 6,118,213 issued on Sep. 12, 2000 to Ilcisin et at. and entitled, “Plasma addressed liquid crystal display device with integrated source of reactive gas,” U.S. Pat. No. 6,153,979 issued on Nov. 28, 2000 to Ilcisin et al. and entitled, “Channel member for a PALC panel,” U.S. Pat. No. 6,172,660 B1 issued on Jan. 9, 2001 to Ilcisin et at. and entitled, “PALC display panel with spacers between the channel member and the cover sheet,” and No. 6,225,029 B1 issued on May 1, 2001 to Bongaerts et al. and entitled, “Plasma addressed liquid crystal display with organic walled plasma channels.” The aforementioned patents and the references contained therein are hereby incorporated by reference as if set forth in their entirety herein.

Some examples of thin display devices such as cathodoluminescent display devices which may be utilized or adapted for use in at least one possible embodiment of the present invention or in which the present invention may possibly have application, may be found in the following U.S. Pat. No. 4,023,064 issued on May 10, 1977 to Schagen et al. and entitled, “Channel plate with color selection electrodes and color phosphors,” U.S. Pat. No. 4,879,496 issued on Nov. 7, 1989 to Knapp et al. and entitled, “Display tube,” U.S. Pat. No. 5,313,136 issued to Van Gorkom et al. and entitled, “Thin-type picture display device,” U.S. Pat. No. 5,371,433 issued on Dec. 6, 1994 to Horne et al. and entitled, “Flat electron display device with spacer and method of making,” U.S. Pat. No. 5,497,046 issued on Mar. 5, 1996 to Van Gorkom et al. and entitled, “Thin-type picture display device,” U.S. Pat. No. 5,789,853 issued on Aug. 4, 1998 to Dings et al. and entitled, “Method of patterned eroding of a coating provided on a substrate,” U.S. Pat. No. 5,905,336 issued on May 18, 1999 to Van Hal et al. and entitled, “Method of manufacturing a glass substrate coated with a metal oxide,” U.S. Pat. No. 6046,714 issued to Lim on Apr. 4, 2000 and entitled “Flat display employing light emitting device and electron multiplier,” U.S. Pat. No. 6,052,160 issued on Apr. 18, 2000 to Bohmer et al. and entitled, “Display device with sputter resistant electrode layer for providing plasma discharge,” U.S. Pat. No. 6,131,410 issued on Oct. 17, 2000 to Swierkowski et al. and entitled, “Vacuum fusion bonding of glass plates,” and U.S. Pat. No. 6,220,741 B1 issued to Kawachi et al. on Apr. 24, 2001 and entitled, “Flat panel display device.” The aforementioned patents and the references contained therein are hereby incorporated by reference as if set forth in their entirety herein.

Some examples of glass channel plates which may be utilized or adapted for use in at least one possible embodiment of the present invention or in which the present invention may possibly have application, may be found in the following U.S. Pat. No. 4,359,663 issued to Shinoda et al. on Nov. 16, 1982 and entitled, “Gas discharge panel having a plurality of shift electrodes,” U.S. Pat. No. 4,713,575 issued to Knapp et al. on Dec. 15, 1987 and entitled, “Method of making a color selection deflection structure, and a color picture display tube including a color selection deflection structure made by the method,” U.S. Pat. No. 4,886,996 issued to Field et al. on Dec. 12, 1989 and entitled, “Channel plate electron multipliers,” U.S. Pat. No. 5,804,920 issued to Khan et al. on Sep. 8, 1998 and entitled, “Plasma addressed liquid crystal display with etched glass spacers,” and U.S. Pat. No. 6,124,676 issued to Salavin et al. on Sep. 26, 2000 and entitled, “Bisubstrate plasma panel.” The aforementioned patents and the references contained therein are hereby incorporated by reference as if set forth in their entirety herein.

Examples of printing a pattern on plates for flat display devices or on a substrate which may possibly be utilized or adapted for use in at least one possible embodiment of the present invention, may be found in U.S. Pat. No. 6,027,864 issued to Baller et al. on Feb. 22, 2000 and entitled, “Method of printing a pattern on plates for a flat display device,” U.S. Pat. No. 4,686,114 issued to Halliwell et al. on Aug. 11, 1987 and entitled, “Selective electro-less plating,” and U.S. Pat. No. 4,348,255 issued to Schmidt on Sep. 7, 1982 and entitled, “Process for the preparation of an optically transparent and electrically conductive film pattern.” The aforementioned patents and the references contained therein are hereby incorporated by reference as if set forth in their entirety herein.

Some examples of etching of glass substrates which may possibly be utilized or adapted for use in at least one possible embodiment of the present invention, may be found in the following U.S. Pat. No. 4,348,255 issued to Schmidt on Sep. 7, 1982 and entitled, “Process for the preparation of an optically transparent and electrically conductive film pattern,” also referred to above, U.S. Pat. No. 4,781,792 issued to Hogan on Nov. 1, 1988 and entitled, “Method for permanently marking glass,” U.S. Pat. No. 5,688,415 issued to Bollinger et al. on Nov. 18, 1997 and entitled, “Localized plasma assisted chemical etching through a mask,” U.S. Pat. No. 5,895,582 issued to Wilson et al. on Apr. 20, 1999 and entitled, “Process of manufacturing a glass substrate for a magnetic disc,” and U.S. Pat. No. 6,045,715 issued to Spierings et al. on Apr. 4, 2000 and entitled, “Method of post-etching a mechanically treated substrate.” The aforementioned patents and the references contained therein are hereby incorporated by reference as if set forth in their entirety herein.

Some examples of glass that may possibly be utilized or adapted for use in at least one possible embodiment of the present invention may be found in the following U.S. Pat. No. 4,824,808 issued to Dumbaugh, Jr. on Apr. 25, 1989 and entitled, “Substrate glass for liquid crystal displays,” and U.S. Pat. No. 6,087,284 issue to Brix et al. on Jul. 11, 2000 and entitled, “Aluminosilicate glass for flat display devices” and its corresponding German patent, No. 197 21 738 C1 filed on May 24, 1997. The aforementioned patents and the references contained therein are hereby incorporated by reference as if set forth in their entirety herein.

Some examples of computer flat panel displays, such a desktop and laptop computers, features of which may possibly be utilized or adapted for use in at least one possible embodiment of the present invention may be found in the following U.S. Pat. No. 5,008,846 issued to Inoue on Apr. 16, 1991 and entitled, “Power and signal supply control device,” U.S. Pat. No. 5,626,991 issued to Hugle on May 6, 1997 and entitled, “Manufacture of flat panel displays,” U.S. Pat. No. 5,708,561 issued to Huilgol et al. on Jan. 13, 1998 and entitled, “Portable computer having display slidably and rotatably mounted for movement between landscape and portrait orientation and to open and close speaker ports,” U.S. Pat. No. 6,208,505 B1 issued to Kuchta et al. on Mar. 27, 2001 and entitled, “Computer keyboard, and flat screen monitor support assembly.” The aforementioned patents and the references contained therein are hereby incorporated by reference as if set forth in their entirety herein.

Some examples of high-precision multiple-disc grinding tools which may possibly be utilized in at least one embodiment of the present invention may be found in German Patent No. 2,039,925 with filing date of Aug. 11, 1970 issued to Toyoda K.K., and Japanese Patent No. 8-318524 with filing date of May 26, 1995. The aforementioned patents and the references contained therein are hereby incorporated by reference as if set forth in their entirety herein.

The paper by I. H. Doyeux and J. Deschamps, “Plasma Display Panel Technology and Applications,” SID 97 DIGEST, on pages 213-217, is hereby incorporated by reference as if set forth in its entirety herein.

Further examples of flat panel and channel plate manufacture, features of which may possibly be utilized or adapted for use in at least one possible embodiment of the present invention may be found in the following U.S. Pat. No. 4,025,328 issued to Polaert et al. on May 24, 1977 and entitled, “Method of manufacturing microchannel plate having rounded input faces,” U.S. Pat. No. 4,252,415 issued to Klein et al. on Feb. 24, 1981 and entitled, “Liquid crystal cell and process for its production,” U.S. Pat. No. 4,514,043 issued to Ahne et al. on Apr. 30, 1985 and entitled, “Method for the preparation of orientation layers for liquid crystal displays and liquid crystal displays having orientation layers,” U.S. Pat. No. 4,613,399 issued to Kobale et al. on Sep. 23, 1986 and entitled, “Method for manufacturing a display device,” U.S. Pat. No. 4,672,193 issued to Duchenois et al. on Jun. 9, 1987 and entitled, “Micro-channel plate support and lead structure,” U.S. Pat. No. 4,713,575 issued to Knapp et al. on Dec. 15, 1987 and entitled, “Method of making a color selection deflection structure, and a color picture display tube including a color selection deflection structure made by the method,” U.S. Pat. No. 4,886,996 issued to Field et al. on Dec. 12, 1989 and entitled, “Channel plate electron multipliers,” U.S. Pat. No. 5,479,071 issued to Lynn on Dec. 26, 1995 and entitled, “Flat form device for creating illuminated patterns,” U.S. Pat. No. 5,086,248 issued to Horton et al. on Feb. 4, 1992 and entitled, “Microchannel electron multipliers,” U.S. Pat. No. 5,386,175 issued to Van Gorkom et al. on Jan. 31, 1995 and entitled, “Thin-type picture display device,” U.S. Pat. No. 5,442,253 issued to Van Gorkom et al. on Aug. 15, 1995 and entitled, “Thin-type picture display device,” U.S. Pat. No. 5,596,431 issued to Bongaerts et al. on Jan. 21, 1997 and entitled, “Plasma addressed liquid crystal display with etched electrodes,” U.S. Pat. No. 5,626,772 issued to Bongaerts et al. on May 6, 1997 and entitled, “Plasma addressed liquid crystal display with etched plasma channels,” U.S. Pat. No. 5,705,079 issued to Elledge on Jan. 6, 1998 and entitled, “Method for forming spacers in flat panel displays using photo-etching,” U.S. Pat. No. 5,733,160 issued to Jeng et al. on Mar. 31, 1998 and entitled, “Method of forming spacers for a flat display apparatus,” U.S. Pat. No. 5,764,001 issued to Khan et al. on Jun. 9, 1998 and entitled, “Plasma addressed liquid crystal display assembled from bonded elements,” U.S. Pat. No. 5,808,413 issued to Bongaerts et al. on Sep. 15, 1998 and entitled, “Plasma addressed liquid crystal display with organic-walled plasma channels,” U.S. Pat. No. 5,840,201 issued to Elledge on Nov. 24, 1998 and entitled, “Method for forming spacers in flat panel displays using photo-etching,” U.S. Pat. No. 5,888,584 issued to Visser-Bartelds et al. on Mar. 30, 1999 and entitled, “Provision of tracks on flat substrates by means of a stencil-printing method,” U.S. Pat. No. 5,910,396 issued to Dings et al. on Jun. 8, 1999 and entitled, “Method of patterned eroding of a coating provided on a substrate,” U.S. Pat. No. 5,936,340 issued to Bechtel et al. on Aug. 10, 1999 and entitled, “Display screen comprising an adhesive layer,” U.S. Pat. No. 5,948 issued to Ostendarp on Sep. 7, 1999 and entitled, “Method and apparatus for making large-scale precision structures in flat glass,” U.S. Pat. No. 5,984,747 issued to Bhagavatula et al. on Nov. 16, 1999 and entitled, “Glass structures for information displays,” U.S. Pat. No. 5,985,069 issued to Kawabe et al. on Nov. 16, 1999 and entitled, “Method of manufacturing a flat display panel and flat display panel,” U.S. Pat. No. 5,987,923 issued to Ostendarp et al. on Nov. 23, 1999 and entitled, “Process and apparatus for hot forming precision structures in flat glass,” U.S. Pat. No. 5,997,713 issued to Beetz, Jr. et al. on Dec. 7, 1999 and entitled, “Silicon etching process for making microchannel plates,” U.S. Pat. No. 6,023,258 issued to Kuriyama et al. and entitled, “Flat display,” U.S. Pat. No. 6,027,864 issued to Baller et al. on Feb. 22, 2000 and entitled, “Method of printing a pattern on plates for a flat display device,” U.S. Pat. No. 6,046,714 issued to Lim on Apr. 4, 2000 and entitled, “Flat display employing light emitting device and electron multiplier,” U.S. Pat. No. 6,057,895 issued to Van Helleputte et al. on May 2, 2000 and entitled, “Plasmas addressed liquid crystal display with deposited plasma channels with tapered edges,” U.S. Pat. No. 6,059,626 issued to Kimura et al. on May 9, 2000 and entitled, “Screen manufacturing method using flat display panel,” and No. 6,225,029 B1 issued to Bongaerts et al. on May 1, 2001 and entitled, “Plasma addressed liquid crystal display with organic-walled plasma channels.” The aforementioned patents are hereby incorporated by reference as if set forth in their entirety herein.

Some examples of glass grinding methods and apparatus features of which may possibly be utilized or adapted for use in at least one possible embodiment of the present invention may be found in the following U.S. Pat. No. 4,375,738 issued to Bando on Mar. 8, 1983 and entitled, “Method for grinding glass plate and the like by numerical control and grinding machine therefor,” U.S. Pat. No. 4,833,832 issued to Lindsey et al. on May 30, 1989 and entitled, “Production of polished flat glass,” U.S. Pat. No. 4,843,764 issued to Bando on Jul. 4, 1989 and entitled, “Glass plate grinding apparatus,” U.S. Pat. No. 4,5,639,289 issued to Flückiger on Jun. 17, 1997 and entitled, “Installation for the treatment of plates,” U.S. Pat. No. 5,807,166 issued to Bando on Sep. 15, 1998 and entitled, “Glass-plate working machine,” and U.S. Pat. No. 6,019,668 issued to Ramanath et al. on Feb. 1, 2000 and entitled, “Method for grinding precision components.” The aforementioned patents are hereby incorporated by reference as if set forth in their entirety herein.

German Patent Publication No, 198 41 900 A1 filed on Sep. 11, 1998 and the references cited therein and in corresponding applications are hereby incorporated as if set forth in their entirety herein.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims. In the claims, means-plus-function clauses are intended to cover the structures described herein as performing the recited function and not only structural equivalents but also equivalent structures.

The invention as described herein above in the context of the preferred embodiments is not to be taken as limited to all of the provided details thereof, since modifications and variations thereof may be made without departing from the spirit and scope of the invention.

What is claimed is:

1. A television flat panel display, said television flat panel display comprising:
a housing;
a viewing screen disposed in said housing;
said viewing screen comprising a first sheet;
said first sheet being disposed in said housing as the front sheet of said flat panel display;
a power input arrangement configured and disposed to power said flat panel display;
an arrangement to produce picture elements as pixels, said arrangement at least comprising:
an array of electrodes;
a material configured to be energized by said electrodes to produce radiation viewable as pixels through said first sheet; and
addressing circuitry connected to said array of electrodes and said power input arrangement;
said addressing circuitry being configured to convert electrical signal input to said material configured to be energized into optical signal output viewable as pixels on a particular point on said first sheet of said flat panel display; and
a channel member;
said material to be energized to produce pixels being disposed in said channel member;
apparatus to maintain said channel member and said first sheet in alignment with respect to one another;
said channel member comprising a plate-like structure;
said plate-like structure having a longitudinal dimension, a transverse dimension transverse to said longitudinal dimension, and a thickness;
said thickness of said plate-like structure being substantially less than either said longitudinal dimension and said transverse dimension;
said channel member comprising a first surface and a second surface;
said first surface being configured as a substantially planar surface;
said second surface being disposed substantially parallel and opposite to said first surface;
said channel member comprising glass;
said second surface comprising a plurality of ribs;
said ribs defining a plurality of grooves extending across said longitudinal dimension and said transverse dimension of said channel member;
said grooves being configured as micro structure channels being spaced apart to correspond to television pixel resolution of said television flat panel display;
said grooves being configured of substantially rectangular u-shape when considered in transverse cross-section;
said grooves comprising bottom surfaces extending towards said first surface;
said ribs extending substantially parallel with respect to one another;
said ribs having a thickness sufficient to provide mechanical stability to said ribs and their corresponding grooves;
said ribs being spaced apart at a predetermined pitch to correspond to pixel resolution of said flat panel display;
said ribs being configured with substantially smooth side walls;
said side walls being disposed substantially perpendicularly to said first surface;
said ribs comprising inner portions and outer portions; said inner portions being disposed between said first surface and said outer portions;
said outer portions projecting away from said first surface;
said channel member comprising at least one peripheral area being configured to support at least portions of said electrodes; and
a transition area being disposed between said groove bottom surfaces and said at least one peripheral area;
said transition area being configured without a step;
said electrodes being disposed in said transition area in a substantially smooth transition from said groove bottom surfaces to said at least one peripheral area, thereby permitting the existence of substantial variations due to manufacturing tolerances in the differences between the level of said at least one peripheral area and the levels of said groove bottom surfaces to occur.

2. The television flat panel display according to claim 1, wherein said transition area comprises an inclined surface between said groove bottom surfaces and said at least one peripheral area.

3. The television flat panel display according to claim 2, wherein:
at least a portion of said at least one peripheral area is disposed at a level between the level of said groove bottom surfaces and said first surface;
said inclined surface extending from the level of said groove bottom surfaces towards said portion of said at least one peripheral area disposed between the level of said groove bottom surfaces and said first surface;
the highest point of said inclined surfaces is disposed at the level of said groove bottom surfaces; and
the lowest point of said inclined surface is disposed at the level between the level of said groove bottom surfaces and said first surface.

4. The television flat panel display according to claim 2, wherein:
the highest point of said inclined surface is disposed at the level of said at least one peripheral area; and
the lowest point of said inclined surface is disposed at said level between the level of said groove bottom surfaces and said first surface; and
the level of said at least one peripheral area is disposed at the level of said outer portions of said ribs.

5. The television flat panel display according to claim 2, wherein said transition area comprises a rounded section disposed between said groove bottom surfaces and said at least one peripheral area.

6. A flat panel display, said flat panel display comprising:
a housing;
a viewing screen disposed in said housing;
said viewing screen comprising a first sheet;
said first sheet being disposed in said housing as the front sheet of said flat panel display;
a power input arrangement configured and disposed to power said flat panel display;
an arrangement to produce picture elements as pixels on said viewing screen, said arrangement at least comprising: an array of electrodes;
a material configured to be energized by said electrodes to produce radiation viewable as pixels through said viewing screen; and
addressing circuitry connected to said array of electrodes and said power input arrangement;
said addressing circuitry being configured to convert electrical signal input to said material to be energized into optical signal output viewable as pixels on a particular point on said first sheet of said flat panel display; and
a channel member;
said channel member comprising a plate-like structure;
said plate-like structure having a longitudinal dimension, a transverse dimension transverse to said longitudinal dimension, and a thickness;
said thickness of said plate-like structure being substantially less than either said longitudinal dimension and said transverse dimension of said plate-like structure;
said channel member comprising a first surface and a second surface;
said second surface being disposed opposite to said first surface;
said second surface comprising a plurality of ribs;
said ribs forming a plurality of grooves extending across said longitudinal dimension and said transverse dimension of said plate-like structure;
said grooves comprising bottom surfaces;
said ribs extending in a predetermined pattern with respect to one another;
said ribs being spaced apart at a predetermined pitch to correspond to pixel resolution of said flat panel display;
said ribs comprising inner portions and outer portions;
said outer portions projecting away from said first surface;
said inner portions being disposed between said first surface and said outer portions;
said channel member comprising at least one peripheral area being configured at the periphery of said channel member and to support at least portions of said electrodes; and
a transition area being disposed between said groove bottom surfaces and said at least one peripheral area;
said transition area being configured substantially without a step;
said electrodes being disposed in said transition area in a substantially stepless transition from said groove bottom surfaces to said at least one peripheral area.

7. The flat panel display according to claim 6, wherein: said transition area comprises an inclined surface between said groove bottom surfaces and said at least one peripheral area.

8. The flat panel display according to claim 7, wherein:
at least a portion of said at least one peripheral area is disposed at a level between the level of said groove bottom surfaces and said first surface;
said inclined surface extending from the level of said groove bottom surfaces towards said portion of said at least one peripheral area disposed between the level of said groove bottom surfaces and said first surface;
the highest point of said inclined surfaces is disposed at the level of said groove bottom surfaces; and
the lowest point of said inclined surface is disposed at the level between the level of said groove bottom surfaces and said first surface.

9. The television flat panel display according to claim 7, wherein:
the highest point of said inclined surface is disposed at the level of said at least one peripheral area;
the lowest point of said inclined surface is disposed at said level between the level of said groove bottom surfaces and said first surface; and
the level of said at least one peripheral area is disposed at the level of said outer portions of said ribs.

10. The television flat panel display according to claim 7, wherein said transition area comprises a rounded section disposed between said groove bottom surfaces and said at least one peripheral area.

11. The television flat panel display according to claim 7, wherein:
said transition area comprises a continuous transition from said groove bottom surfaces to said at least one peripheral area to provide said smooth transition of said electrodes from said groove bottom surfaces to said at least one peripheral area;
said transition area comprises an inclined surface between said groove bottom surfaces and said at least one peripheral area;
the highest point of said inclined surface is disposed at the level of said groove bottom surfaces; and
the lowest point of said inclined surface is disposed at said level between the level of said groove bottom surfaces and said first surface;
said continuous transition area comprises a ground transition area;
said grooves comprise grooves ground into said glass of said plate-like structure; and
at least one of said first and second surfaces comprises a high-precision ground surface.

12. The flat panel display according to claim 6, wherein said groove bottom surfaces comprise ground surfaces configured by a grinding wheel.

13. The flat panel display according to claim 12, wherein:
at least one of said first and second surfaces of said channel member being configured with minimized deviations; and
said deviations being substantially smaller than the thickness of said plate-like structure due to high-precision surface grinding.

14. The flat panel display according to claim 13, wherein:
said channel member comprises a glass substrate and further comprises:
a non-transparent layer having a thickness of one of (i.) and (ii.):
(i.) a thickness that is substantially less than the corresponding depth of a corresponding groove;
(ii.) a thickness that is at least equal to the depth of said grooves; and
said flat panel display comprises one of (iii.) and (iv.):
(iii.) a flat panel plasma display; and
(iv.) a flat panel plasma addressed liquid crystal display.

15. A method of manufacture of a flat panel display, said method comprising the steps of:
providing a housing;
disposing a viewing screen in said housing;
said viewing screen comprising a first sheet;
said first sheet being disposed in said housing as the front sheet of said flat panel display;
arranging a power input arrangement configured and disposed to power said flat panel display;
making an arrangement to produce picture elements as pixels on said viewing screen, which arrangement at least comprises:
an array of electrodes;
a material configured to be energized by said electrodes to produce radiation viewable as pixels through said viewing screen;
addressing circuitry connected to said array of electrodes and said power input arrangement; and
said addressing circuitry being configured to convert electrical signal input to said material to be energized into optical signal output viewable as pixels on a particular point on said first sheet of said flat panel display;
forming a channel member comprising a plate-like structure, said plate-like structure having a longitudinal dimension, a transverse dimension transverse to said longitudinal dimension, and a thickness;
said thickness of said plate-like structure being substantially less than either said longitudinal dimension and said transverse dimension of said plate-like structure;
said channel member comprising a first surface and a second surface; said second surface being disposed opposite to said first surface; said second surface comprising a plurality of ribs; said ribs forming a plurality of grooves extending across said longitudinal dimension and said transverse dimension of said plate-like structure; said ribs extending in a predetermined pattern with respect to one another; said ribs having a thickness sufficient to provide mechanical stability to said ribs and their corresponding grooves; said ribs being spaced apart at a predetermined pitch to correspond to pixel resolution of said flat panel display; said ribs comprising inner portions and outer portions; said outer portions projecting away from said first surface; said inner portions being disposed between said first surface and said outer portions;
said forming of said channel member comprising the steps of:
shaping at least one peripheral area about the periphery of said channel with sufficient extent to support at least portions of said electrodes;
forming said plurality of grooves with predetermined depth in said plate-like structure by grinding and thus disposing said grooves adjacent to one another in conformity with said pitch to correspond to pixel resolution of said flat panel display;
forming a transition area, adjacent said at least one peripheral area, between said groove bottom surfaces and said at least one peripheral area, configured substantially without a step, thereby permitting the existence of substantial variations, due to manufacturing tolerances, in the differences between the level of said at least one peripheral area and the levels of said groove bottoms to occur;
disposing said electrodes on said groove bottom surfaces and on said at least one peripheral area; and
also disposing said electrodes on said transition area to form a substantially stepless transition from said groove bottom surfaces to said at least one peripheral area; said method further comprising the steps of:
introducing into said channel member said material to be energized to produce pixels; and
providing apparatus to maintain said channel member and said first sheet in alignment with respect to one another in said housing.

16. The method according to claim 15, wherein said grinding of said grooves is accomplished by one of (i.) and (ii.):
(i.) high-precision multiple-disc grinding, and
(ii.) off-set grinding.

17. The method according to claim 16, wherein:
at least a portion of said at least one peripheral area is disposed at a level between the level of said groove bottom surfaces and said first surface; and
said forming of said transition area comprises grinding an inclined surface extending from the level of said groove bottom surfaces towards said portion of said at least one peripheral area disposed between the level of said groove bottom surfaces and said first surface;
with the highest point of said inclined surface being disposed at the level of said groove bottom surfaces; and
the lowest point of said inclined surface being disposed at the level between the level of said groove bottom surfaces and said first surface.

18. The method according to claim 16, wherein:
the level of said at least one peripheral area is disposed at the level of said outer portions of said ribs; and
said forming of said transition area comprises one of (i.) and (ii.):
(i.) grinding an inclined surface extending from the level of said at least one peripheral area disposed at the level of said grooves furthest from said first surface to the level of said groove bottom surfaces; and
(ii.) grinding a rounded section between said groove bottom surfaces and said at least one peripheral area.

19. The method according to claim 15, wherein said forming of said transition area includes simultaneously rotating the disc of a multiple-disc grinding tool and moving said grinding tool into said channel member at a predetermined angle, in reference to said first surface, by one of (i.) and (ii.):
(i.) perpendicular to said first surface into said channel member; and
(ii.) at a predetermined angle with respect to said first surface.

20. The method according to claim 19, wherein said grinding tool is moved in the direction away from said at least one peripheral area to form said grooves.
